(19) United States
(12) Patent Application Publication
(10) Pub. No.: US 2025/0033359 A1
(43) Pub. Date: Jan. 30, 2025

(54) CONTROL METHOD OF LIQUID EJECTION DEVICE AND LIQUID EJECTION DEVICE

(71) Applicant: SEIKO EPSON CORPORATION, Tokyo (JP)

(72) Inventors: Satoshi CHIBA, SUWA-SHI (JP); Kazuhiko SATO, MATSUMOTO-SHI (JP); Mikinori SAWAI, ITABASHI-KU (JP); Kazushi KODAIRA, SHIOJIRI-SHI (JP); Yasuhiro HOSOKAWA, SHIOJIRI-SHI (JP)

(21) Appl. No.: 18/787,170

(22) Filed: Jul. 29, 2024

(30) Foreign Application Priority Data
Jul. 28, 2023 (JP) 2023-123129

(51) Int. Cl. B41J 2/165; B41J 2/045; B41J 2/175

(52) U.S. Cl. CPC B41J 2/1652; B41J 2/0451; B41J 2/04581; B41J 2/16535; B41J 2/17596; B41P 2235/20

(57) ABSTRACT

The liquid ejection device includes a liquid ejection section, a pressurizing section, a wiping section, and a detection section. The pressurizing section causes the liquid to bulge from the plurality of nozzles by pressurization. The detection section detects a nozzle with which a droplet adhering to the nozzle surface comes into contact. The control method of the liquid ejection device includes causing the liquid to bulge from the plurality of nozzle groups by the pressurization of the pressurizing section which is an ejection of liquid not related to the recording, from the plurality of nozzles based on the set dummy ejection amount.

The present application is based on, and claims priority from JP Application Serial Number 2023-123129, filed Jul. 28, 2023, the disclosure of which is hereby incorporated by reference herein in its entirety.

### BACKGROUND

### 1. Technical Field

The present disclosure relates to a control method of a liquid ejection device including a liquid ejection section that ejects liquid, and the liquid ejection device.

### 2. Related Art

JP-A-2019-14264 discloses a liquid ejection device including a head unit (an example of a liquid ejection section) that ejects liquid. The liquid ejection device includes a liquid container that contains liquid, a liquid ejection head that ejects the liquid, and a supply flow path that supplies the liquid from the liquid container to the liquid ejection head. In order to discharge ink of other colors that was drawn-in from the nozzles by wiping or the like, dummy ejection (flushing) is performed in which ink is ejected from all the nozzles of the head unit.

However, because dummy ejection (flushing) is uniformly performed from all nozzles in order to prevent color mixing, the dummy ejection amount cannot be set according to the state of each nozzle, and the amount of liquid such as ink that is wastefully discharged from the nozzles increases. For this reason, there is a problem in that it is desirable to suppress the amount of liquid that is wastefully discharged from the nozzles due to the dummy ejection. Not only a liquid ejection device such as a printer that ejects ink, but also a liquid ejection device that ejects a liquid other than ink has the same problem.

### SUMMARY

According to solve the above-described problems, a control method of a liquid ejection device, the liquid ejection device having a liquid ejection section configured to record by ejecting liquid from a plurality of nozzle groups formed in a nozzle surface, a pressurizing section configured to cause the liquid to bulge from the plurality of nozzle groups by pressurizing the liquid in the plurality of nozzle groups, a wiping section configured to wipe the nozzle surface, and a detection section configured to detect a nozzle that is in contact with a liquid droplet adhering to the nozzle surface, the control method of the liquid ejection device includes causing the liquid to bulge from the plurality of nozzle groups by pressurization of the pressurizing section, in a state where an operation at the time when pressurization by the pressurizing section is being maintained, performing wiping of the nozzle surface by the wiping section and detection by the detection section, based on a detection result by the detection section, setting a dummy ejection amount for each of the plurality of nozzles constituting the plurality of nozzle groups, releasing the pressurization of the pressurizing section, and based on the set dummy ejection amount, performing a dummy ejection, which is an ejection of liquid not related to the recording, from the plurality of nozzles.

According to solve the above-described problems, a liquid ejection device includes a liquid ejection section configured to record by ejecting liquid from a plurality of nozzle groups formed on an nozzle surface, a pressurizing section configured to cause the liquid to bulge from the plurality of nozzle groups by pressurizing the liquid in the plurality of nozzle groups, a wiping section configured to wipe the nozzle surface, a detection section configured to detect a nozzle in contact with a droplet adhering to the nozzle surface, and control section, wherein the control section is configured to cause the liquid to bulge from the plurality of nozzle groups by the pressurization of the pressurizing section, in a state where an operation of the pressurizing section at the time of pressurization is maintained, execute wiping of the nozzle surface by the wiping section and detection by the detection section, set a dummy ejection amount of each of the plurality of nozzles constituting the plurality of nozzle groups based on a detection result by the detection section, releases the pressurization of the pressurizing section, and based on the set dummy ejection amount, execute dummy ejection which is ejection of liquid not related to the recording from the plurality of nozzles.

### BRIEF DESCRIPTION OF THE DRAWINGS

FIG. 1 is a perspective view illustrating a liquid ejection device according to an embodiment.

FIG. 2 is a schematic front cross-sectional view illustrating internal configuration of the liquid ejection device.

FIG. 3 is a schematic view showing a liquid ejection mechanism and a maintenance section.

FIG. 4 is a bottom view of the liquid ejection head.

FIG. 5 is a schematic bottom view showing a nozzle array and a wiping section of the liquid ejection head.

FIG. 6 is a partially cut-view of schematic front view showing the pressurizing section when the on-off valve is closed.

FIG. 7 is a partially cut-view of schematic front view showing the pressurizing section in the pressurizing position.

FIG. 8 is a partially cut-view of schematic front view showing the pressurizing section at the pressurizing position in a state where the on-off valve is opened.

FIG. 9 is a partially cut-view of schematic front view showing the pressurizing section in which the on-off valve is in the pressurization release position.

FIG. 10 is a schematic cross-sectional view showing the state of the liquid in the nozzles during printing.

FIG. 11 is a schematic cross-sectional view showing the liquid which bulges from the nozzle during pressurization.

FIG. 12 is a schematic cross-sectional view showing the liquid in the nozzle during wiping.

FIG. 13 is a schematic cross-sectional view showing the liquid in the nozzle when the pressurization is released.

FIG. 14 is a schematic cross-sectional view showing a state of the mixed color liquid remaining on the nozzle surface after wiping.

FIG. 15 is a schematic cross-sectional view showing a state in which the mixed color liquid is sucked into the nozzle.

FIG. 16 is a cross-sectional view showing configuration of the ejection section.

FIG. 17 is a block diagram illustrating an electrical configuration of the liquid ejection device.

FIG. 18 is a block diagram showing an electrical configuration relating to ejection abnormality detection.

FIG. 19 is a circuit diagram showing an equivalent circuit relating to ejection abnormality detection.

FIG. 20 is a graph showing a relationship between the residual vibration signal and the ejection abnormality.

FIG. 21 is a graph showing the detection result of the nozzle inspection section after wiping.

FIG. 22 is a schematic cross-sectional view of the liquid ejection head showing the first nozzles targeted for the first dummy ejection in the first embodiment.

FIG. 23 is a schematic cross-sectional view of the liquid ejection head showing the first nozzles targeted for the first dummy ejection.

FIG. 24 is a schematic cross-sectional view of the liquid ejection head showing the first nozzles targeted for the first dummy ejection in the second embodiment.

FIG. 25 is a schematic cross-sectional view of the liquid ejection head showing the first nozzles targeted for the first dummy ejection.

FIG. 26 is a schematic cross-sectional view of the liquid ejection head showing the first nozzles targeted for the first dummy ejection in the third embodiment.

FIG. 27 is a schematic cross-sectional view of the liquid ejection head showing the first nozzles targeted for the first dummy ejection.

FIG. 28 is a flowchart showing a maintenance control routine.

### DESCRIPTION OF EMBODIMENTS

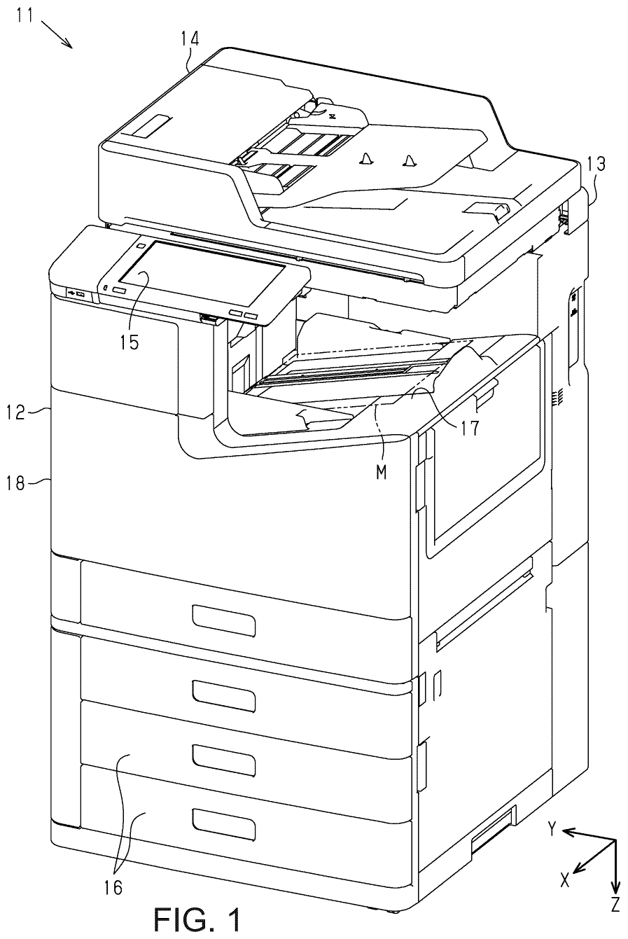

Hereinafter, a liquid ejection device and a control method thereof according to a present embodiment will be described with reference to the drawings. A liquid ejection device 11 illustrated in FIG. 1 is, for example, an inkjet-type printer that performs recording by ejecting ink, which is an example of liquid, onto a medium M such as a sheet. In FIG. 1, it is assumed that the liquid ejection device 11 is placed on a horizontal plane, the direction of gravity is indicated by a Z-axis, and directions along the horizontal plane are indicated by an X-axis and a Y-axis. The X-axis, the Y-axis, and the Z-axis are orthogonal to each other.

As illustrated in FIG. 1, the liquid ejection device 11 may include a device main body 12, an image reading section 13 that reads an image of a document, and an auto feeding device 14 that feeds a document to the image reading section 13. The liquid ejection device 11 may include an operation section 15, which is operated in order for a user to instruct the liquid ejection device 11, a medium accommodation section 16, which can accommodate the medium M such as paper, and a stacker 17, which receives the medium M which is discharged after printing. The operation section 15 may be, for example, a touch panel, a button, or a combination thereof. The medium accommodation section 16 can accommodate plural sheets of medium M in a stacked state. The liquid ejection device 11 may include a plurality of medium accommodation sections 16.

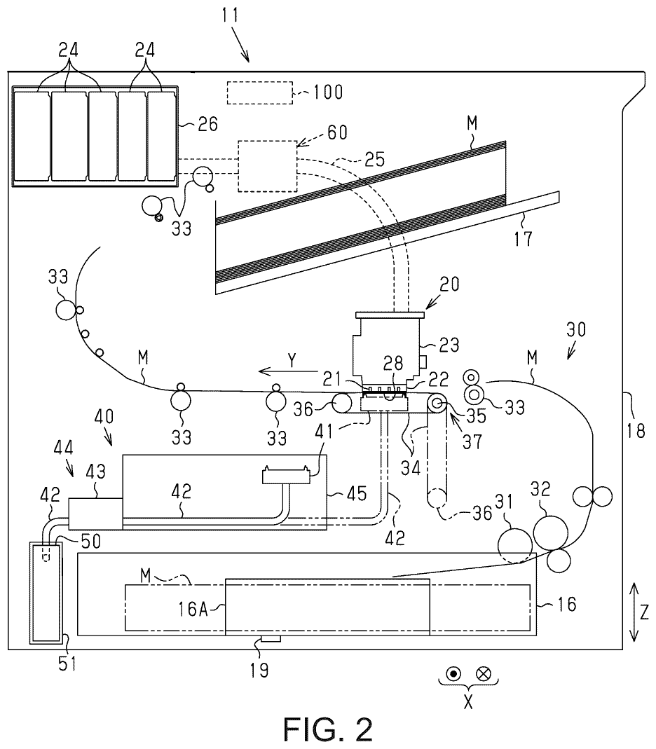

Next, internal configuration of the liquid ejection device 11 will be described with reference to FIG. 2. As shown in FIG. 2, the device main body 12 includes a housing 18 having a substantially rectangular parallelepiped shape. The liquid ejection device 11 includes, in the housing 18, a liquid ejection section 20, a transport section 30 which transports the medium M, a maintenance section 40 which performs maintenance of a liquid ejection head 22, and a control section 100 which controls constituent components including thereof.

The liquid ejection section 20 includes the liquid ejection head 22 in which a plurality of nozzles 21 capable of discharging liquid droplets are opened, and a support section 23 that holds the liquid ejection head 22 at a predetermined height. The plurality of nozzles 21 is opened in a nozzle surface 28, which is a surface (for example, a bottom surface) of the liquid ejection head 22 facing a transport path through which the medium M is transported.

The liquid ejection head 22 ejects liquid onto the medium M. Assuming that the position where the liquid ejection head 22 ejects liquid is called a recording position, printing is performed by ejecting liquid from the nozzles 21 toward the medium M at the recording position. The liquid ejection head 22 of the present embodiment is a line head having a plurality of nozzles 21 that can simultaneously eject liquid over the entire width region of the medium M in the width direction X, which intersects (in the embodiment, is orthogonal to) the transport direction Y and the ejecting direction Z. The liquid ejection device 11 performs line printing by ejecting liquid from the plurality of nozzles 21 at positions facing the entire width region of the medium M toward the medium M being transported at a constant speed that corresponds to the printing mode.

The liquid ejection head 22 is supported by the support section 23 in a state of extending in the width direction X, which intersects the transport direction Y of the medium M. The liquid ejection head 22 is configured to eject liquid onto the medium M from a plurality of nozzles 21 constituting a plurality of nozzle groups. A supply flow path 25 for supplying the liquid of a liquid container 24 is connected to the liquid ejection head 22. A plurality of liquid containers 24 is mounted on a holder 26 in the housing 18.

The plurality of liquid containers 24 respectively contain different kinds of liquids. In an example in which the liquid is ink, the liquid containers 24 each contain different colored ink. In this example, the plurality of liquid containers 24 contain black ink and color ink. The liquid containers 24 contain inks of black, yellow, cyan, and magenta. That is, the liquid containers 24 are a black-liquid container 24K, a yellow-liquid container 24Y, a cyan-liquid container 24C, and a magenta-liquid container 24M. Because of the large ink consumption amount from the black-liquid container 24K, a plurality of (for example, two) black-liquid containers 24K may be mounted as in the example illustrated in FIG. 2, or the black-liquid container 24K may have a larger volume than the other ink colors. The number of liquid containers 24 is not limited to the example of five liquid containers 24 shown in FIG. 2 and can be appropriately changed according to the number of ink colors, and may be 6 to 10, or 1 to 4.

The liquid container 24 is, for example, a liquid cartridge detachably attached to the holder 26, but may be a liquid tank. In the case of the liquid tank, a configuration may be adopted in which the liquid is replenished by the user injecting the liquid from a container such as a bottle.

The transport section 30 includes a feed roller 31 that feeds the medium M one by one from the uppermost sheet from the group of the medium M stacked in the medium accommodation section 16 and a separation roller 32 that separates the medium M one by one. Further, the transport section 30 includes a plurality of transport rollers 33 that transport the medium M along a transport path, which is a path passing through the recording position, and a transport belt 34 that transports the medium M at the recording position. The transport belt 34 is wound around a first roller 35 and a second roller 36.

The transport belt 34 is configured to rotate about the first roller 35. The transport belt 34 is moved by a support-section movement mechanism 37 between a support position indicated by solid line in FIG. 2 and a retreat position indicated by two-dot chain line in FIG. 2. The transport belt 34 supports the medium M being transported at the support position. That is, the transport belt 34 has a function as a support section that supports the medium M so as to maintain the constant gap between the transported medium M and the liquid ejection head 22. Here, the transport direction Y refers to a transport direction of the medium M at the recording position.

The medium accommodation section 16 is, for example, a cassette, and is detachably inserted into a concave portion (not illustrated) formed in the housing 18. In the inserted state shown in FIG. 2, the medium M accommodated in the medium accommodation section 16 is housed in the housing 18. In FIG. 2, only the uppermost one of the medium accommodation sections 16 is shown, and the others are omitted.

The medium accommodation section 16 includes a movable edge guide 16A that is operated by the user. The medium M in the medium accommodation section 16 is positioned in the widthwise direction by the edge guide 16A. The liquid ejection device 11 may include a size detection section 19 illustrated in FIG. 2 that detects the size of the medium M accommodated in the medium accommodation section 16.

The liquid ejection device 11 includes a waste liquid container 50 that contains waste liquid generated due to maintenance or the like of the liquid ejection head 22. The waste liquid container 50 is detachably attached to a holder 51. The waste liquid container 50 attached to the holder 51 is housed at a predetermined position in the housing 18.

The maintenance section 40, in the liquid ejection head 22, performs a maintenance operation such as dummy ejection and cleaning in order to prevent or eliminate discharge failure caused by clogging of the nozzles 21 or adhesion of foreign matter.

The maintenance section 40 includes a plurality of caps 41 configured to cover the plurality of nozzle groups, a discharge mechanism 44 that discharges the liquid in the caps 41, and a cap movement mechanism 45 that moves the caps 41. The discharge mechanism 44 includes a waste liquid flow path 42 that couples a cap 41 and the holder 51, and a decompression unit 43 located at an intermediate position of the waste liquid flow path 42. The liquid ejection device 11 includes the waste liquid container 50 that contains the waste liquid discharged from the cap 41 by the discharge mechanism 44.

The cap movement mechanism 45 moves the cap 41 between a retreat position indicated by solid line in FIG. 1 and a capping position (indicated by two-dot chain line in FIG. 1) at which the cap 41 is in contact with the nozzle surface 28 of the liquid ejection head 22. When the cap 41 is moved to the capping position, the transport belt 34 retreats from a support position indicated by solid line in FIG. 2 to a retreat position indicated by two-dot chain line in FIG. 2.

The capping is performed by the cap 41 moving to the capping position and coming into contact with the nozzle surface 28 of the liquid ejection head 22 so as to surround the nozzles 21. When the ejection of the liquid is not performed, the occurrence of the ejection failure is prevented by suppressing the thickening of the liquid in the nozzle 21 by performing the capping in times when ejection of the liquid is not being performed.

Here, dummy ejection is a discharge operation for maintenance in which liquid droplets not related to printing are discharged from the nozzles 21 for the maintenance of the liquid ejection head 22. Dummy ejection is also referred to as flushing. By performing dummy ejection, thickened ink, air bubbles, or foreign matter, which causes ejection failures, is discharged from the nozzles 21. The liquid discharged as waste liquid by the dummy ejection is received by the cap 41. The cap 41 is located at the capping position during flushing periods, maintenance periods, and at the end of printing. At the time of flushing, the liquid ejection head 22 performs dummy ejection by discharging liquid droplets from the nozzles 21 toward the cap 41.

Cleaning is performed by driving the decompression unit 43 in a state where the cap 41 is located at the capping position. Cleaning of the present embodiment is suction cleaning in which the liquid is sucked and discharged from the nozzles 21 by producing a negative pressure in the substantially closed space between the nozzle surface 28 and the cap 41. The waste liquid flow path 42 is coupled to one end portion of the cap 41 on the side opposite to the opening. The other end portion of the waste liquid flow path 42 is coupled to the holder 51 via the decompression unit 43. The cap 41 communicates with the waste liquid container 50 via the waste liquid flow path 42, the decompression unit 43, and the holder 51.

The liquid discharged from the nozzles 21 to the cap 41 by the cleaning is stored as waste liquid in the waste liquid container 50 through the waste liquid flow path 42 from the cap 41. Once a predetermined amount of waste liquid discharged from the nozzles 21 by the dummy ejection accumulates in the cap 41, the liquid in the cap 41 is collected in the waste liquid container 50 through the waste liquid flow path 42 by driving the decompression unit 43 in a state where the cap 41 is separated from the liquid ejection head 22 by a predetermined gap distance. This suction is referred to as dummy suction. Dummy suction is performed to discharge the liquid accumulated in the cap 41.

As shown in FIG. 2, a liquid supply mechanism 60 is provided at an intermediate position of the supply flow path 25 between the liquid container 24 and the liquid ejection section 20. The liquid supply mechanism 60 has a function of supplying the liquid and pressurizing the liquid to cause the liquid to bulge from the nozzle 21 for maintenance.

### Regarding Configuration of Liquid Supply Mechanism 60

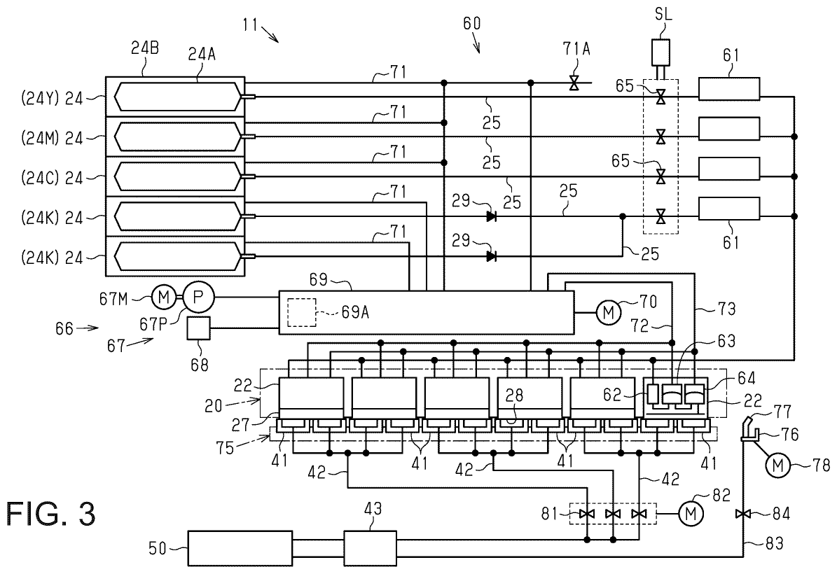

Next, the liquid supply mechanism 60 will be described with reference to FIG. 3. The liquid container 24 includes a liquid pack 24A for containing a liquid and a case 24B for housing the liquid pack 24A. When the liquid container 24 is attached to the holder (not shown), the liquid pack 24A is coupled to the supply flow path 25 and the case 24B is coupled to a first air flow path 71. The liquid container 24 supplies liquid from the liquid pack 24A when the space in the case 24B is pressurized. When the liquid is ink, the liquid pack 24A is an ink pack.

The liquid supply mechanism 60 includes a sub-tank 61, a self-sealing valve 62, an on-off valve 63, a head tank 64, and the like provided at intermediate positions of the supply flow path 25. The self-sealing valve 62, the on-off valve 63, and the head tank 64 are provided for each liquid ejection head 22 constituting the liquid ejection section 20. The on-off valve 63 is, for example, a choke valve used in choke cleaning to be described later.

In the supply flow path 25, for example, a plurality of flow valves 65 driven by a solenoid SL are provided in a portion between the liquid container 24 and the sub-tank 61. When printing is performed, a flow valve 65 is opened, and the liquid from the liquid container 24 is supplied to the sub-tank 61. The sub-tank 61 is provided with an end sensor (not shown) that detects that the amount of liquid stored in the sub-tank 61 has become equal to or less than a threshold value. When the end sensor detects the end of the liquid, the flow valve 65 is closed by the control section 100. In the example of FIG. 2, the supply flow paths 25 coupled to the two black-liquid containers 24K are coupled together upstream of the sub-tank 61. Check valves 29 that allow the liquid to be supplied in a liquid supplying direction from the liquid containers 24K to the sub-tank 61 and prevent the liquid from moving in a direction opposite to the liquid supplying direction are provided at intermediate positions of the respective supply flow paths 25 coupled to the black-liquid containers 24K.

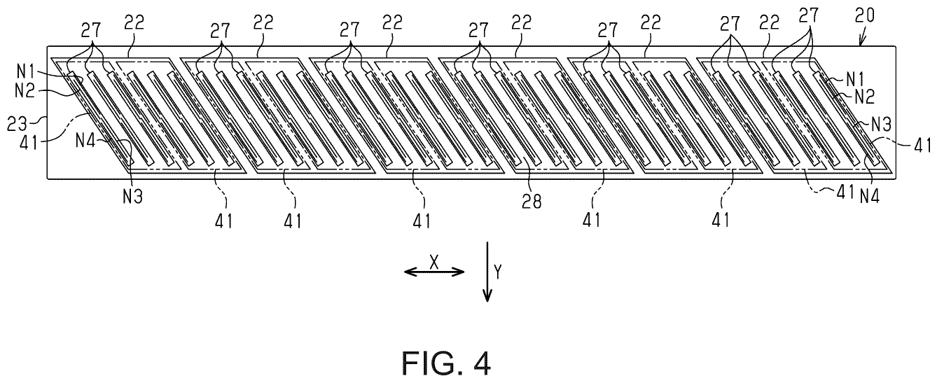

The liquid supply mechanism 60 includes a pressurizing section 66 that generates and controls the air pressure when the on-off valve 63 and the head tank 64 are driven by the air pressure. The pressurizing section 66 pressurizes the liquid in a plurality of nozzle groups N1 to N4 (refer to FIG. 4). The pressurizing section 66 causes the liquid to bulge from the nozzles 21 by pressurizing the liquid in the nozzles 21.

The pressurizing section 66 includes a liquid chamber 95 provided at an intermediate position of the supply flow path 25, which supplies liquid to the liquid ejection section 20, the on-off valve 63 provided on the upstream side of the liquid chamber 95 in the supply flow path 25, and a drive section 67 that can displace a membrane member 97 configuring a portion of a wall portion that forms the liquid chamber 95. That is, the pressurizing section 66 includes the on-off valve 63, the head tank 64, and the drive section 67 that generates and controls the air pressure for driving the on-off valve 63 and the head tank 64. The liquid chamber 95 is configured such that its volume can be changed by the displacement of the membrane member 97. The on-off valve 63 is configured to open and close the supply flow path 25.

The drive section 67 includes a motor 67M, a pressurizing pump 67P driven by the motor 67M, a pressure sensor 68 that detects the air pressure from pressurization by the pressurizing pump 67P, a selector valve 69 that selects a destination of the pressurized air pressure, and a motor 70 coupled to the selector valve 69. The selector valve 69 includes a pressurizing tank 69A (not shown) therein. The pressure sensor 68 detects the air pressure in the pressurizing tank 69A. The motor 70 is a drive source of the selector valve 69. When the control section 100 controls the rotational position of the motor 70, the opening and closing of each valve (for example, an on-off valve) in the selector valve 69 is selected, and thus the derivation destination of the air pressure from the selector valve 69 is selected.

In order to pressurize a liquid pack 24A (for example, an ink pack) in the liquid container 24, the selector valve 69 is coupled to one end of the first air flow path 71, whose other end is coupled to the liquid container 24. The selector valve 69 is coupled to one end of a second air flow path 72 and of a third air flow path 73, of which other ends are coupled to the air chambers of the on-off valve 63 and the head tank 64 of each liquid ejection head 22. The first air flow path 71 is provided with an atmospheric relief valve 71A.

As shown in FIG. 3, the maintenance section 40 is provided with a cap unit 75 having the plurality of the above-described caps 41, and a wiping section 76 capable of wiping the nozzle surface.

The cap 41 has a bottomed box shape that opens upward and is configured to be relatively movable regarding the nozzle surface 28 of the liquid ejection head 22. The cap 41 moves from the retreat position in a direction approaching the liquid ejection head 22 and moves to a flushing position separated from the nozzle surface 28 by a gap distance and a capping position where a substantially closed space is formed by the nozzle surface 28 and the cap 41 by contact with the nozzle surface 28. The position of the cap 41 when the liquid ejection head 22 performs dummy ejection is the flushing position.

The wiping section 76 includes a wiper blade 77 that wipes the nozzle surface 28. In a state where the cap 41 is retreated to the retreat position (refer to FIG. 2), the wiping section 76 wipes the nozzle surfaces 28 of the plurality of liquid ejection heads 22 by moving in the width direction X of the medium M by a driving force of a motor 78, which is the driving source of the wiping section 76.

The plurality of caps 41 is coupled to the waste liquid container 50 through the waste liquid flow path 42. A decompression tank (not shown) and a plurality of on-off valves 81 is provided at an intermediate position of the waste liquid flow path 42. The plurality of on-off valves 81 is opened and closed by the power of a motor 82 controlled by the control section 100. When the on-off valve 81 is opened, negative pressure is introduced into the cap 41, and when the on-off valve 81 is closed, negative pressure is not introduced into the cap 41. In a state where the cap 41 is in contact with the nozzle surface 28 of the liquid ejection head 22, a negative pressure is introduced into the cap 41, and thus suction cleaning in which the liquid is forcibly sucked and discharged from the nozzles 21 is performed. The cleaning may be pressure cleaning in which the liquid is forcibly discharged from the nozzles 21 by pressurizing the liquid container 24.

The liquid that was wiped from the nozzle surface 28 accumulates in the wiping section 76. A portion of the wiping section 76 where the liquid accumulates is coupled to the waste liquid container 50 through a discharge flow path 83. An on-off valve 84 is provided at an intermediate position of the discharge flow path 83. When the on-off valve 84 is opened by the control of the control section 100, the waste liquid is collected in the waste liquid container 50 from the wiping section 76 through the discharge flow path 83.

### Regarding Configuration of Nozzle Surface of Liquid Ejection Section 20

Next, the configuration of the nozzle surface of the liquid ejection section 20 will be described with reference to FIG. 4.

As shown in FIG. 4, the liquid ejection section 20 is configured to perform recording by ejecting liquid from a plurality of nozzle groups N1 to N4 formed on the nozzle surface 28. Specifically, a plurality of the unit-ejection heads 27 are arranged at regular intervals in the width direction X on the bottom of the liquid ejection head 22 included in the liquid ejection section 20. The plurality of the unit-ejection heads 27 is arranged in a posture inclined by a predetermined angle with respect to the transport direction Y in which the medium M is transported.

For example, one cap 41 indicated by two-dot chain line in FIG. 4 faces every three unit-ejection heads 27. As shown in FIG. 4, the cap 41 has a parallelogram opening shape in a plan view (that is, a bottom view), and can cap the unit-ejection head 27 arranged obliquely with respect to the transport direction Y three by three.

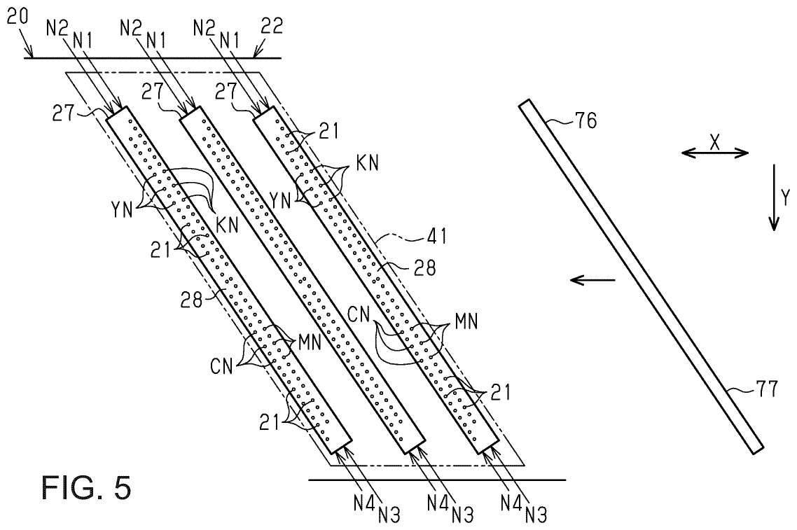

FIG. 5 shows three unit-ejection heads 27, which are units to be capped by one cap 41 in the liquid ejection head 22. The unit-ejection head 27 has a plurality of (for example, four rows of) nozzle groups N1 to N4 in which a plurality of nozzles 21 opening to the nozzle surface 28 are arranged in rows. In each of the nozzle groups N1 to N4, a predetermined number of nozzles 21 are arranged in a line along the longitudinal direction of the unit-ejection heads 27. Although the number of nozzles 21 is simplified in FIG. 5, the nozzles 21 actually form one nozzle group by a predetermined number (for example, about 400) within a range of 200 to 1000.

The liquid ejection device 11 of the present embodiment can perform color printing. In an example in which the liquid is ink, the nozzles 21 include a nozzle KN that discharges black ink, a nozzle YN that discharges yellow ink, a nozzle MN that discharges magenta ink, and a nozzle CN that discharges cyan ink. The nozzle group N1 is constituted by a plurality of nozzles KN arranged in a row at a constant nozzle pitch. The nozzle group N2 is constituted by a plurality of nozzles YN arranged in a row at a constant nozzle pitch. The nozzle group N3 is constituted by a plurality of nozzles MN arranged in a row at a constant nozzle pitch. The nozzle group N4 is constituted by a plurality of nozzles CN arranged in a row at a constant nozzle pitch.

The positions of the nozzles KN, YN, MN, and CN projected in the transport direction Y are arranged at equal intervals for each color over the entire region in the width direction of the medium M in the maximum width. That is, the distance of the equal interval is a dot pitch when printing is performed on the medium M. In this way, in the liquid ejection head 22, the unit-ejection heads 27 are disposed at a predetermined inclination angle so that the projected nozzles when the nozzles 21 are projected in the transport direction Y are arranged in the width direction at a pitch corresponding to the printing resolution.

As shown in FIG. 5, in the liquid ejection section 20, a nozzle group N1, which is a group of black nozzles KN, and a nozzle group N2, which is a group of yellow nozzles YN, are adjacent to each other and a nozzle group N3, which is a group of magenta nozzles MN, and a nozzle group N4, which is a group of cyan nozzles CN, are adjacent to each other. Therefore, yellow color and black color are easily mixed. Also, cyan color and magenta color are easily mixed. In a case where mixed color inks are ejected from the mixed color nozzles 21, streaks of mixed-colors are likely to occur in printing on the medium M. In particular, in a case where the black ink is mixed in the yellow nozzle YN, a dark color streak is generated on the light color print, and thus the streak due to the color mixture is likely to be conspicuous.

As shown in FIG. 5, the nozzle surface 28 of the liquid ejection section 20 is wiped by the wiping section 76 moving in the width direction X. By this wiping, the openings of the nozzles 21 constituting the plurality of nozzle groups N1 to N4 is wiped together with the nozzle surface 28. The bottom surface of the liquid ejection head 22 is formed so that the unit-ejection heads 27 and other portions are substantially flush with each other, and the entire bottom surface serves as the nozzle surface 28 wiped by the wiping section 76.

In the embodiment, when the wiping section 76 wipes the nozzle surface 28, the liquid in the nozzles 21 is pressurized by the pressurizing section 66 (refer to FIG. 3). The wiping section 76 wipes the nozzle surface 28 in a state in which the liquid bulges from all nozzles 21 due to the pressurization. The details of the control during wiping will be described later.

### Regarding Configuration and Operation of Pressurizing Section 66

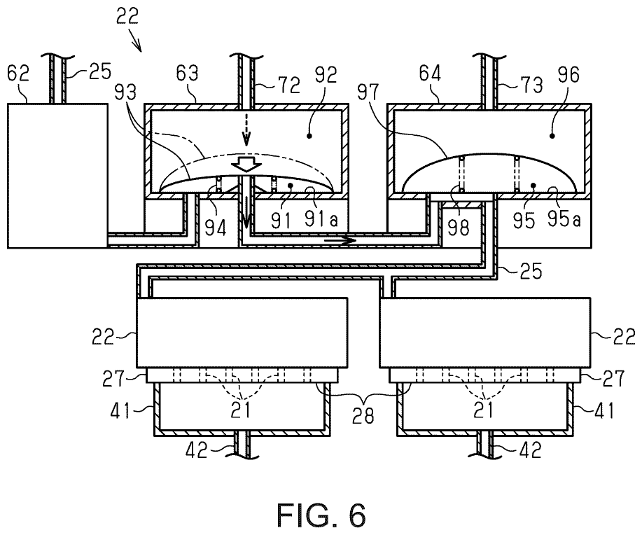

Next, the configuration and operation of the pressurizing section 66 will be described with reference to FIGS. 6 to 9. The self-sealing valve 62, the on-off valve 63, and the head tank 64, which constitute the pressurizing section 66, are provided in this order at intermediate positions of the supply flow path 25 along the liquid supply direction. The self-sealing valve 62 opens the supply flow path 25 by a difference between the pressure of the supply flow path 25 and atmospheric pressure. That is, the self-sealing valve 62 is configured to open the supply flow path 25 and replenish the ink from the upstream side when the liquid is consumed from the liquid ejection head 22 and the downstream side has a negative pressure. The self-sealing valve 62 includes a valve body (not shown) that opens and closes the supply flow path 25, a biasing member (not shown) that biases the valve body in a closing direction, and a flexible member (not shown) that receives the atmospheric pressure and pushes and opens the valve body against the biasing of the biasing member when the supply flow path 25 has a negative pressure.

The on-off valve 63 is provided downstream of the self-sealing valve 62. The on-off valve 63 includes a liquid chamber 91 that forms a part of the supply flow path 25 and an air chamber 92 that is separated from the liquid chamber 91 via a membrane member 93. The on-off valve 63 opens and closes the supply flow path 25 by deforming the membrane member 93 due to a pressure difference between the liquid chamber 91 and the air chamber 92. The working pressure of the on-off valve 63 can be adjusted by a working-pressure adjusting spring 94.

The liquid chamber 91 is formed inside the housing of the on-off valve 63, and a part of the wall thereof is formed by the membrane member 93. An inlet of the liquid chamber 91 is formed in a bottom surface 91a, and an outlet of the liquid chamber 91 is formed above the bottom surface 91a. Therefore, when the membrane member 93 is recessed toward the bottom surface 91a side, the outlet of the liquid chamber 91 is closed. Thus, the on-off valve 63 can close the supply flow path 25.

The air chamber 92 is positioned to be separated from the liquid chamber 91 by the membrane member 93 in the internal space of the housing of the on-off valve 63. The membrane member 93 is formed of, for example, a flexible resin film (for example, an elastomer or the like). The membrane member 93 is fixed to the inner wall surface of the on-off valve 63 with a predetermined slack to cover the inlet and the outlet of the liquid chamber 91. The working-pressure adjusting spring 94 adjusts the working pressure of the on-off valve 63, is disposed in the liquid chamber 91, and biases the membrane member 93 toward the air chamber 92.

The head tank 64 is provided downstream of the on-off valve 63. The head tank 64 includes the liquid chamber 95, which forms a part of the supply flow path 25, and an air chamber 96 separated from the liquid chamber 95 via the membrane member 97. The head tank 64 deforms the membrane member 97 by a pressure difference between the liquid chamber 95 and the air chamber 96 to change the space volume of the liquid chamber 95. The working pressure of the head tank 64 can be adjusted by a working-pressure adjusting spring 98.

The liquid chamber 95 is formed inside a head tank 64, and a part of its wall surface is formed by the membrane member 97. An inlet and an outlet of the liquid chamber 95 are formed below a bottom surface 95a. Therefore, even if the membrane member 97 is recessed toward the bottom surface 95a side, the supply flow path 25 in the head tank 64 is not blocked. The air chamber 96 is located in the internal space of the head tank 64, on the opposite side from the liquid chamber 95 across the membrane member 97.

The membrane member 97 is formed of, for example, a flexible resin film (for example, an elastomer or the like). The membrane member 97 is fixed to the inner wall surface of the head tank 64 with a predetermined slack to cover the inlet and the outlet of the liquid chamber 95. The working-pressure adjusting spring 98 adjusts the working pressure of the head tank 64, is in the liquid chamber 95, and biases the membrane member 97 toward the air chamber 96.

The supply flow path 25 communicating with the outlet of the liquid chamber 95 of the head tank 64 is coupled to the liquid ejection head 22.

For example, when the cleaning is performed, a capping state in which the cap 41 comes into contact with the nozzle surface 28 is set. When the nozzle surface 28 is wiped by the wiping section 76, a small amount of liquid compared to the cleaning is discharged from the nozzles 21 in advance. After the discharge, the nozzle surface 28 is wiped by the wiping section 76 in a state in which the liquid bulges from the nozzles 21. Note that the liquid may only be caused to bulge from the nozzle 21 without being accompanied by the liquid discharge from the nozzle 21.

The cleaning includes a first cleaning (wiping cleaning) performed before wiping and a second cleaning performed by the maintenance section 40. As the first cleaning, there is wiping cleaning for recovering the ejection characteristics of the liquid ejection head 22 by replacing a small amount of ink. As the second cleaning, there are normal cleaning in which the ink is replaced while the on-off valve 63 is opened, and choke cleaning in which the ink is replaced by opening and closing the on-off valve 63.

### Regarding First Cleaning

Next, the first cleaning will be described with reference to FIGS. 6 to 15. By switching the selector valve 69 in the wiping cleaning, as shown in FIG. 6, air is introduced into the air chamber 92 of the on-off valve 63. As a result, the membrane member 93 warps from the open position indicated by two-dot chain line to the closed position indicated by solid line in FIG. 6, whereby the on-off valve 63 is closed.

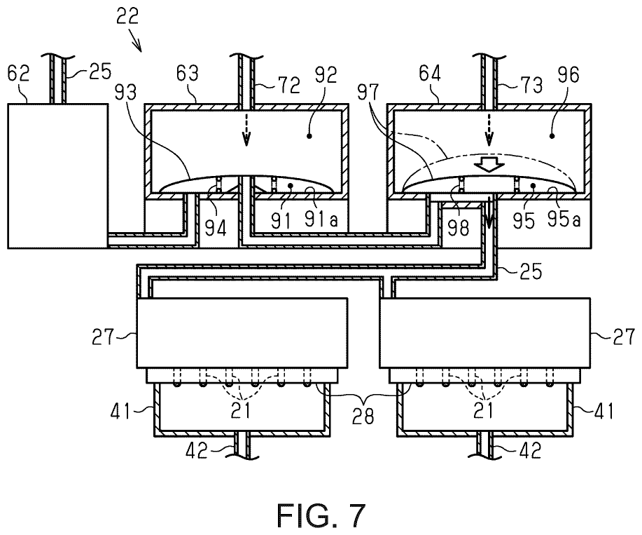

Next, when the selector valve 69 is switched, as shown in FIG. 7, air is introduced into the air chamber 96 of the head tank 64 in a state where the on-off valve 63 is closed. As a result, the membrane member 97 is bent from a non-pressurizing position indicated by two-dot chain line in FIG. 7 to a pressurizing position indicated by solid line, whereby the liquid in the liquid chamber 95 is pressurized. In this way, the first cleaning is performed.

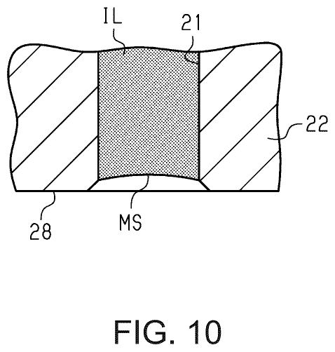

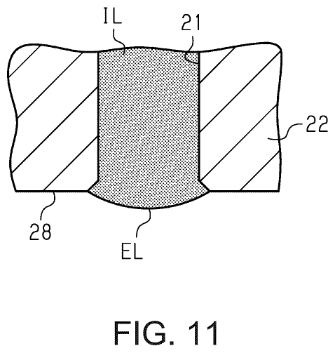

The first cleaning will be described with reference to FIGS. 10 to 12 showing cross sectional view of the nozzles. As shown in FIG. 10, the liquid IL in the nozzle 21 of the liquid ejection head 22 forms a concave meniscus MS that is recessed deeper toward depth direction from the opening of the nozzle 21 than the nozzle surface 28. From this state, in the head tank 64, the membrane member 97 is operated to the pressurizing position shown in FIG. 7, whereby the liquid pushed out (pressurized) from the liquid chamber 95 is discharged from the nozzle 21 in a small amount corresponding to the volume of the liquid chamber 95. As a result, as shown in FIG. 11, the liquid IL bulges from the nozzle 21. In the process in which the bulging section EL is formed, the liquid IL may be discharged from the nozzle 21, or the pressurized liquid may remain in a state of bulging from the opening of the nozzle 21 without being discharged.

The nozzle surface 28 is wiped by the wiping section 76 in a state where the liquid bulges from the nozzles 21 as shown in FIG. 11. For example, when wiping is performed in a state in which the concave meniscus MS shown in FIG. 10 is formed, a film of the wiped liquid IL is formed on the outer side of the concave of the meniscus MS, and air is trapped between the film and the meniscus MS. This air may become air bubbles and adversely affect the liquid ejection performance during subsequent printing.

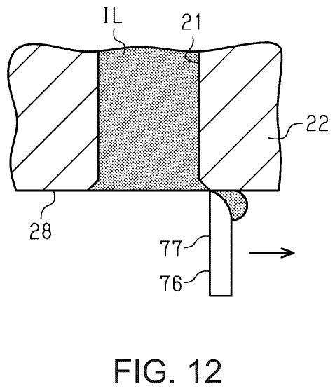

On the other hand, as shown in FIG. 12, when the bulging section EL where the liquid IL bulges from the nozzle 21 is wiped by the wiping section 76, it is possible to avoid the air from being trapped in the liquid IL in the nozzle 21, and thus it is possible to prevent the bubbles from being mixed into the nozzle 21. Because a small amount of the liquid IL is discharged, the thickened liquid IL, air bubbles, or the like in the nozzles 21 are discharged from the nozzles 21.

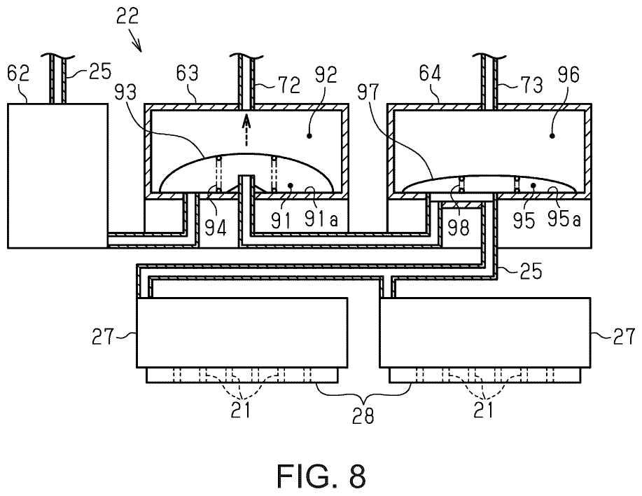

As shown in FIG. 8, when the pressure of the air chamber 92 of the on-off valve 63 is reduced to atmospheric pressure, the membrane member 93 bends to the swelling side, and the on-off valve 63 is opened.

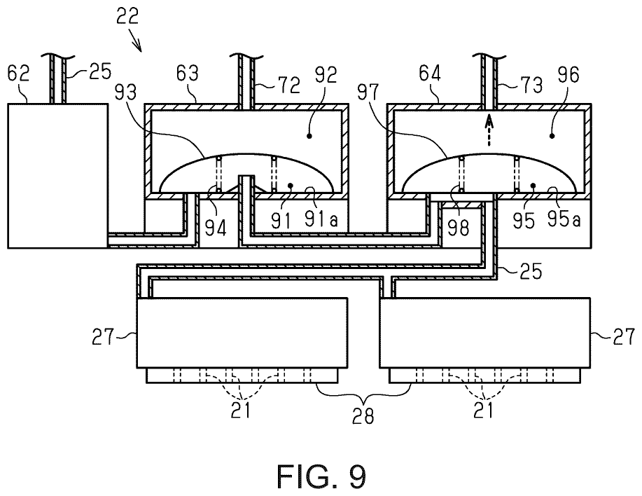

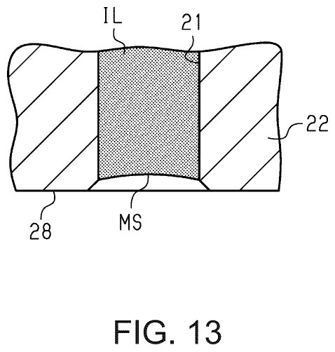

Next, the air chamber 96 of the head tank 64 is depressurized to the atmospheric pressure so that, as shown in FIG. 9, the membrane member 97 of the head tank 64 is displaced from the pressurizing position to the non-pressurizing position. As a result, a force that sucks the liquid from the nozzle 21 side acts on the liquid chamber 95. Therefore, as shown in FIG. 13, the liquid IL in the nozzle 21 is sucked in the depth direction. As a result, the meniscus MS of the liquid IL is formed at the opening of the nozzle 21.

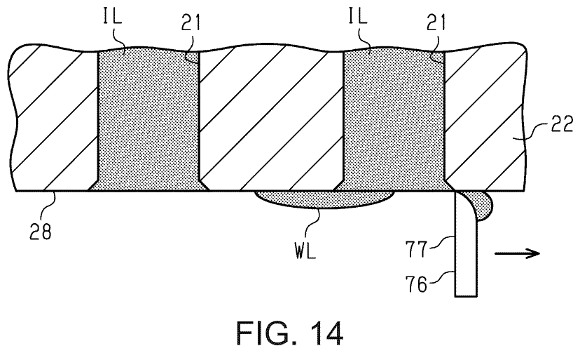

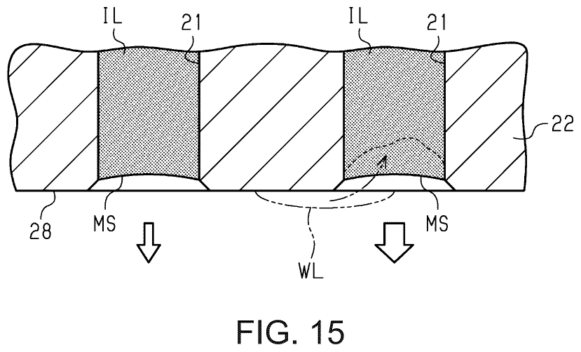

For example, as shown in FIG. 14, there are cases where the liquid IL that accumulates along the ridge line of the wiper blade 77, when the wiping section 76 wipes the nozzle surface 28, remains on the nozzle surface 28 for some reason. The adhering liquid WL remaining on the nozzle surface 28 is a mixed-color liquid. As shown in FIG. 14, the remaining adhering liquid WL may come into contact with the nozzle 21. In this case, thereafter, as shown in FIG. 15, the mixed-color adhering liquid WL may be sucked into the nozzles 21 by the suction when the head tank 64 moves from the pressurizing position to the non-pressurizing position.

In the present embodiment, the mixed-color adhering liquid WL in contact with the nozzle 21 shown in FIG. 14 is detected. After the detection, the nozzle 21 (see FIG. 15) that might have sucked the mixed-color liquid IL is specified. From the specified nozzle 21, dummy ejection is performed with a dummy ejection amount larger than a normal dummy ejection amount. For example, when dummy ejection is performed in an amount that can discharge the sucked in mixed-color adhering liquid WL uniformly to both nozzles 21 that have sucked in the mixed-color adhering liquid WL and to nozzles 21 that have not sucked in the mixed-color adhering liquid WL, then excessive liquid will be wastefully discharged from nozzles 21 that have not sucked in the mixed-color adhering liquid WL. Therefore, in the present embodiment, the nozzles 21 that have sucked in the mixed-color adhering liquid WL are detected and for specific nozzles 21 specified based on the detection result, a first dummy ejection indicated by a large white arrow in FIG. 15 is performed in which the liquid IL is discharged from the nozzles 21 in a first ejection amount, which is an amount capable of discharging the mixed-color adhering liquid WL. Then, for normal nozzles 21 other than the specific nozzles 21, a second dummy ejection indicated by a small outlined-arrow in FIG. 15 is performed in which the liquid IL is discharged at a second ejection amount that is smaller than the first ejection amount.

### Regarding Configuration of Driving System of Liquid Ejection Head 22

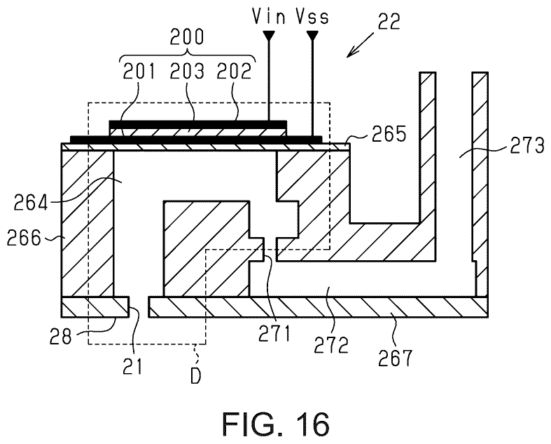

Next, with reference to FIG. 16, a detailed configuration of a portion including a driving system for ejecting the liquid of the liquid ejection head 22 will be described.

The liquid ejection head 22 includes an ejection section D provided for each nozzle 21. The ejection section D illustrated in FIG. 16 includes the nozzle 21, an actuator 200, a cavity 264 (pressure chamber), a diaphragm 265, and the like. The nozzle 21 communicates with the cavity 264. The ejection section D ejects liquid (for example, ink) in the cavity 264 from the nozzle 21 by the diaphragm 265 vibrating due to the driving of the actuator 200. FIG. 16 illustrates one of the ejection sections D, which are in the same number as the plurality of nozzles 21.

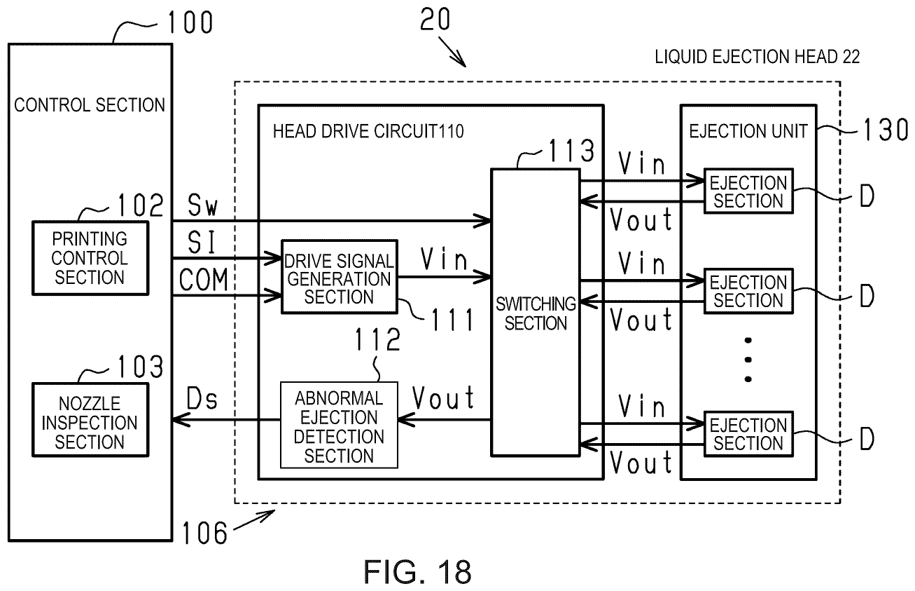

The liquid ejection section 20 includes the ejection section D illustrated in FIG. 16 in the same number as the number of nozzles 21. That is, the liquid ejection section 20 includes the plurality of diaphragms 265 and the plurality of actuators 200 provided in correspondence with the plurality of nozzles 21 constituting the plurality of nozzle groups N1 to N4. The actuators 200 are individually driven by a head drive circuit 110 (shown in FIG. 18), as an example of a drive circuit, to partially displace the diaphragms 265. The displaced diaphragm 265 causes the liquid to be ejected from the nozzle 21 corresponding to the driven actuator 200.

The cavity 264 is a space partitioned by a cavity plate 266 formed in a predetermined shape having a concave portion, a nozzle plate 267 in which the nozzles 21 are formed, and the diaphragm 265. The cavity 264 communicates with a reservoir 272 via a liquid supply inlet 271. The reservoir 272 communicates with one liquid container 24 via a liquid supply flow path 273.

The actuator 200 may be, for example, a unimorph (monomorph) type piezoelectric element as shown in FIG. 16. In this case, the piezoelectric element constituting the actuator 200 includes a bottom electrode 201, a top electrode 202, and a piezoelectric body 203 provided between the bottom electrode 201 and the top electrode 202. When the bottom electrode 201 is set to a predetermined reference potential VSS and the drive signal Vin is supplied to the top electrode 202, a voltage is applied between the bottom electrode 201 and the top electrode 202 in the actuator 200. The actuator 200 bends and vibrates in the vertical direction in FIG. 3 in response to the applied voltage. In this example, the bottom electrode 201 is a common electrode that is common to the plurality of actuators 200, and the top electrodes 202 are individual electrodes that individually supply the drive signals Vin to the plurality of actuators 200.

The bottom electrode 201 of the actuator 200 is bonded to the diaphragm 265 installed in a state of closing the top surface opening portion of the cavity plate 266. Therefore, when the actuator 200 is vibrated by the drive signals Vin, the diaphragm 265 is also vibrated. Then, the volume of the cavity 264 changes due to the vibration of the diaphragm 265, and the pressure of the liquid in the cavity 264 changes accordingly, whereby a part of the liquid filled in the cavity 264 is ejected from the nozzle 21.

The liquid is supplied from the reservoir 272 to the cavity 264 and the cavity 264 is replenished with the liquid by the amount of the liquid in the cavity 264 decreased by the ejection of the liquid. The liquid is supplied to the reservoir 272 from the liquid container 24 via the liquid supply flow path 273. The liquid supply flow path 273 communicates with the supply flow path 25 shown in FIG. 2.

In the present embodiment, the piezoelectric element is used as the actuator 200, but the actuator 200 is not limited to the piezoelectric element. For example, the actuator 200 may be configured to include an electrostatic element or may be a heater element that boils liquid such as ink by heating and ejects the liquid from the nozzle 21 by the force of bubbles.

### Electrical Configuration of Liquid Ejection Device 11

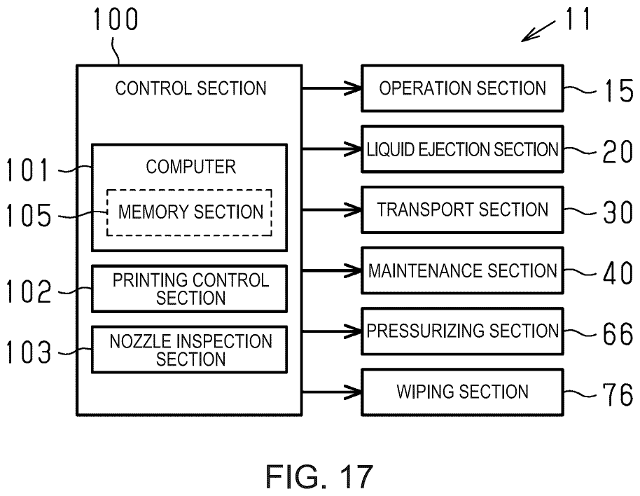

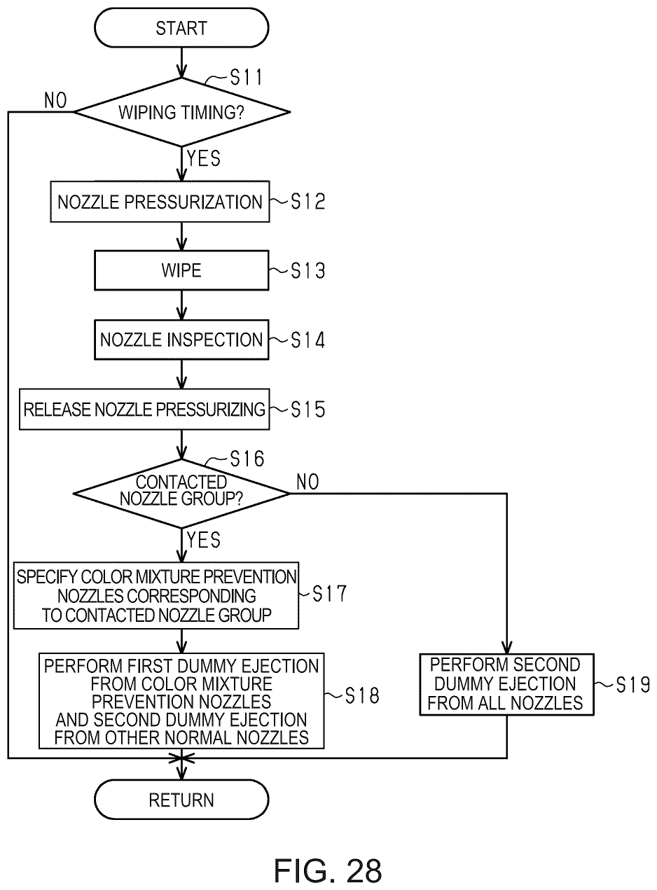

Next, an electrical configuration of the liquid ejection device 11 will be described with reference to FIG. 17. As shown in FIG. 17, the control section 100 is electrically coupled to the operation section 15, the liquid ejection section 20, the transport section 30, the maintenance section 40, the pressurizing section 66, the wiping section 76, and the like. The control section 100 includes a computer 101 and an electronic circuit such as an FPGA (field-programmable gate array). The control section 100 includes a printing control section 102 and a nozzle inspection section 103. The printing control section 102 and the nozzle inspection section 103 are configured by at least one of the computers 101 and the electronic circuit. The computer 101 includes a memory section 105. The memory section 105 stores a program such as a maintenance control routine, illustrated by a flowchart in FIG. 28, or the like. The control section 100 executes a program such as a maintenance control routine by the computer 101.

The control section 100 is not limited to a control section that performs software processing for all processing executed by the control section 100. For example, the control section 100 may include a dedicated hardware circuit, for example, an application specific integrated circuit (ASIC), that performs hardware processing for at least a part of the processing executed by the control section 100. That is, the control section 100 can be configured as a circuit (circuitry) including one or more processors that operate according to a computer program (software), one or more dedicated hardware circuits that execute at least a part of various processes, or a combination thereof. The processor includes a CPU and memory, such as RAM and ROM, which stores program code or instructions configured to cause the CPU to perform processes. Memory, that is, a computer-readable medium, includes any available medium that can be accessed by a general purpose or special purpose computer. At least a part of the control section 100 may be configured by hardware. That is, the control section 100 may be realized by cooperation of software and hardware or may be realized by hardware.

The printing control section 102 performs various kinds of control such as printing control, maintenance control, and wiping control. The printing control section 102 controls the plurality of ejection sections D, for example, by outputting a control signal to the head drive circuit 110 as an example of a drive circuit in the liquid ejection head 22 (shown in FIG. 18).

The nozzle inspection section 103 performs nozzle inspection for inspecting the existence of an ejection abnormality of the nozzles 21 of the liquid ejection head 22. The nozzle inspection section 103 uses nozzle inspection to detect a nozzle having an ejection abnormality. The nozzle inspection section 103 of the present example inspects the ejection abnormality of the nozzle 21 based on a detection signal from an abnormal-ejection detection section 112 (refer to FIG. 18), which will be described later.

### Electrical Configuration Related to Ejection Control and Ejection Abnormality Detection

Next, an electrical configuration related to the control of the liquid ejection head 22 and the ejection abnormality detection performed by the control section 100 will be described with reference to FIG. 18. As illustrated in FIG. 18, the control section 100 is electrically coupled to the liquid ejection head 22 via a wiring cable (not illustrated) in a state where various signals Sw, SI, COM, and Ds can be transmitted and received.

The liquid ejection head 22 includes the head drive circuit 110 and an ejection unit 130. The head drive circuit 110 includes a drive signal generation section 111 that generates the drive signal Vin based on the signals SI and COM, which are input from the printing control section 102, and the abnormal-ejection detection section 112 that detects an ejection abnormality (abnormal nozzle) of the nozzle 21 based on the residual vibration signal Vout from the ejection section D. In the embodiment, a detection section 106 is configured by the abnormal-ejection detection section 112 and the nozzle inspection section 103. The detection section 106 detects the nozzle 21 in contact with adhering liquid WL adhering to the nozzle surface 28 based on the residual vibration of the displaced diaphragm 265.

The head drive circuit 110 includes a switching section 113 that switches a coupling destination with the ejection section D between the drive signal generation section 111 and the abnormal-ejection detection section 112. The switching section 113 switches between a first coupling state in which the ejection section D and the drive signal generation section 111 are electrically coupled and a second coupling state in which the ejection section D and the abnormal-ejection detection section 112 are electrically coupled based on the switching signal Sw from the nozzle inspection section 103. That is, the switching section 113 switches the output of the drive signal Vin from the drive signal generation section 111 toward the ejection section D and the input of the residual vibration signal Vout from the ejection section D to the abnormal-ejection detection section 112.

When the drive signal Vin is supplied from the head drive circuit 110 to the actuator 200 (refer to FIG. 16) included in the ejection section D, the diaphragm 265 of the ejection section D is bent upward by the electrostrictive action of the piezoelectric element constituting the actuator 200, and then is restored by its elastic restoring force. At this time, due to the pressure applied to the liquid (for example, ink) in the cavity 264 (refer to FIG. 16), liquid droplets are ejected from the nozzle 21 which communicates with the cavity 264.

The drive signal generation section 111 generates drive signals Vin for driving each of the plurality of ejection sections D included in the ejection unit 130 based on the control signals such as the pass data SI and the drive waveform signal COM supplied from the printing control section 102. Each of the ejection sections D is driven based on the drive signal Vin, and ejects the liquid filled therein from the nozzle 21 to the medium M. The drive signal generation section 111 can generate the drive signals Vin including a voltage waveform to vibrate the diaphragm 265 with an amplitude that can eject liquid from the nozzle 21, and the drive signals Vin including a voltage waveform for minutely vibrating the diaphragm 265 with a small amplitude to an extent that does not eject liquid from the nozzle 21. The nozzle inspection by the detection section 106 is performed by slightly vibrating the diaphragm 265 but may be performed by discharging liquid droplets from the nozzles 21.

The abnormal-ejection detection section 112 inputs the residual vibration signal Vout output by the actuator 200 which receives the residual vibration of the liquid in the cavity 264 of the ejection section D via the diaphragm 265 (refer to FIG. 16) after the ejection section D is driven by the drive signal Vin. Based on the input residual vibration signals Vout, the abnormal-ejection detection section 112 detects whether the nozzle 21 to be inspected is a normal nozzle, which can normally eject liquid droplets, or an abnormal nozzle, which cannot normally eject liquid droplets, and outputs the detection result to the control section 100 as a detection signal Ds. In a case where the detection result is an abnormal nozzle, the abnormal-ejection detection section 112 outputs the detection signal Ds for each of a plurality of causes (mixing of air bubbles, drying, adhesion of paper dust) together with nozzle position information to specify the position of the abnormal nozzle.

In the ejection abnormality inspection, vibration of the diaphragm 265 of each ejection section D due to the excitation remains after the end of the ejection operation of one ink droplet or one excitation operation for minutely vibrating the ink in the nozzle 21, until the next excitation operation starts. It can be assumed that the residual vibration generated in the diaphragm 265 of the ejection section D has a natural vibration frequency determined by the acoustic resistance Res due to the shape of the nozzle 21 or the liquid supply inlet 271 or the viscosity of the ink, the inertance Int due to the weight of the ink in the flow path, and the compliance Cm of the diaphragm 265 or the like.

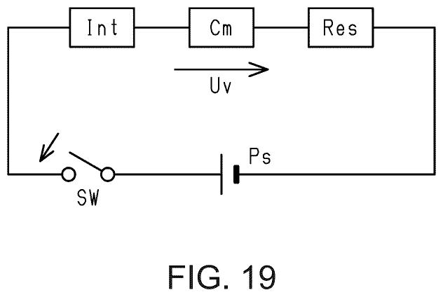

FIG. 19 shows an equivalent circuit representing a calculation model of simple harmonic motion assuming the residual vibration of the diaphragm 265 based on the above assumption. The calculation model of the residual vibration of the diaphragm 265 is represented by the sound pressure Ps, inertance Int, the compliance Cm, and the acoustic resistance Res. Then, the step response when the sound pressure Ps is applied to the circuit of FIG. 19 can be calculated for the volume velocity Uv.

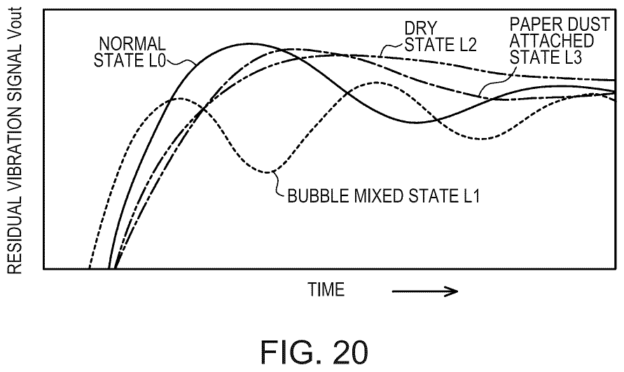

FIG. 20 is a graph showing waveforms of residual vibration signals Vout. As shown in FIG. 20, when the ejection section D normally ejects liquid droplets, the residual vibration signal Vout has a predetermined waveform in a normal state (see “NORMAL STATE L0” in FIG. 20). However, in the case of ejection abnormality in which the ejection of liquid droplets is abnormal, the waveform of the residual vibration signal Vout is different from that in the normal state. Specifically, as shown in FIG. 20, in a case where air bubbles are mixed in the liquid in the nozzle 21 or the cavity 264, the residual vibration signal Vout becomes the residual vibration waveform L1 in a bubble mixed state. In a case where the liquid in the nozzle 21 is thickened or solidified by drying, the residual vibration signal Vout becomes the residual vibration waveform L2 in the dry state. Further, in a case where paper dust is attached to the opening of the nozzle 21, the residual vibration signal Vout becomes the residual vibration waveform L3 in the paper dust attached state in which the cycle is longer than that at the time of normal ejection. As described above, it is possible to detect the ejection abnormality of the liquid droplets of the liquid ejection head 22 for each cause by the difference in the residual vibration.

As shown in FIG. 14, in a case where the mixed-color liquid WL is attached to the nozzle surface 28 in a state of being in contact with the nozzle 21, the weight of the liquid increases, and the inertance Int increases. Therefore, the waveform of the residual vibration signal Vout is different between a nozzle 21 contacted by the mixed-color liquid WL adhering to the nozzle surface 28 and the nozzle 21 with not contact with mixed-color liquid WL. The contact of the mixed-color liquid WL with the nozzle 21 includes contact between the mixed-color liquid WL and the opening of the nozzle 21.

### Regarding the Method of Detecting the Liquid Adhesion State on the Nozzle Surface 28

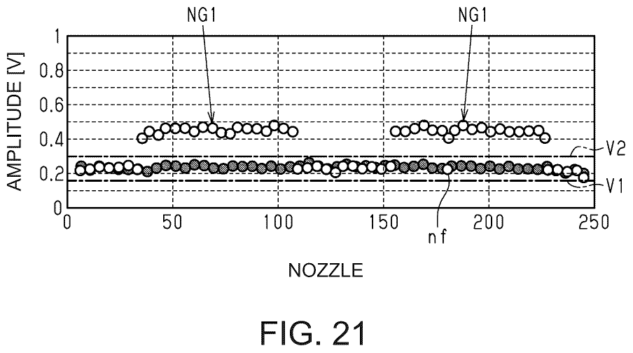

Next, with reference to FIG. 21, a description will be given of a detection example in which the nozzle inspection section 103, which inspects ejection failures of the nozzles 21, is used to detect the liquid adhesion state on the nozzle surface 28. The graph shown in FIG. 21 shows a detection example in which the nozzles 21 contacted by liquid attached to the nozzle surface 28 are detected. The horizontal axis of the graph represents the positions of the n nozzles 21 arranged in the width direction X. In this graph, n is an example of about 240. The vertical axis represents the amplitude (V) of the residual vibration signal Vout. The amplitude is indicated by a voltage. In the graph of FIG. 21, a lower limit V1 and an upper limit V2, which are indicated by single dot chain line, indicate the lower limit and the upper limit of normal ranges in which fall the amplitudes of the normal nozzles 21, which do not contact liquid adhering to the nozzle surface 28, that is, the adhering liquid WL (refer to FIGS. 14 and 15). The amplitude of the abnormal nozzle in contact with the adhering liquid WL deviates from the normal range. As shown in FIG. 21, the amplitude of nozzles 21 in contact with adhering liquid WL deviates from the normal range to the larger side. Therefore, it is possible to detect whether a nozzle 21 is an abnormal nozzle 21, which is contacted by the adhering liquid WL, or a normal nozzle 21, which is not contacted by the adhering liquid WL, based on the amplitude of the residual vibration signals Vout using the mechanism of the nozzle inspection.

In the graph of FIG. 21, a dark dot indicates a detection example in a case where the liquid is not attached to the nozzle surface 28, and a white dot indicates a detection example in a case where the liquid is attached to the nozzle surface 28. In the example shown in FIG. 21, the abnormal nozzles 21 in contact with the adhering liquid WL form a group, and the group of these abnormal nozzles is referred to as a contacted nozzle group NG1. FIG. 21 shows an example in which contacted nozzle groups NG1 appear at two positions. In the present embodiment, these contacted nozzle groups NG1 are also referred to as “first nozzle groups NG1”. The amplitudes of the normal nozzles 21 other than the first nozzle groups NG1 take values within the normal range. By the way, in the range in which the contacted nozzle group NG1 shown in FIG. 21 exists, a single nozzle nf indicated by a white dot and with an amplitude within the normal range is presumed to be a false detection. For this reason, in consideration of this type of erroneous detection, there are cases where it is appropriate to regard a nozzle adjacent to the abnormal nozzle belonging to the first nozzle groups NG1 as an abnormal nozzle.

When the pressurization is released, the nozzle 21 in contact with the adhering liquid WL sucks the adhering liquid WL of the mixed-color into the nozzle 21 (refer to FIGS. 14 and 15). Therefore, in order to discharge the mixed-color liquid WL that was sucked into the nozzle 21 from the nozzle 21, the dummy ejection for discharging liquid unrelated to printing from the nozzle 21 is performed. The amount of the mixed-color liquid WL sucked by the nozzle 21 is an amount corresponding to the capacity of the liquid chamber 95 because the head tank 64 moves from the pressurizing position to the non-pressurizing position. Therefore, in order to discharge the mixed-color liquid WL sucked from the nozzle 21 by the dummy ejection, the liquid is discharged by a dummy ejection amount larger than that of the normal dummy ejection. In the present embodiment, the dummy ejection for discharging the mixed-color liquid having a larger dummy ejection amount than the normal dummy ejection is also referred to as a first dummy ejection. On the other hand, dummy ejection from the nozzles 21 other than the mixed-color liquid corresponding nozzles is also referred to as second dummy ejection.

### Specifying Method of First Nozzle

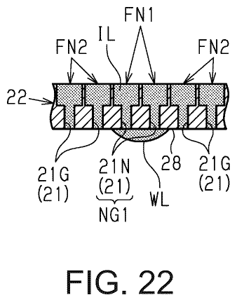

Next, with reference to FIGS. 22 to 27, three examples of a method of determining the nozzles 21 to be subjected to the first dummy ejection after wiping the nozzle surface 28 will be described. Here, in FIGS. 22 to 27, the nozzles 21 that contacting adhering liquid WL and that in the nozzle inspection by the detection section 106 have amplitudes that deviate from the normal ranges are referred to as “abnormal nozzles 21N”, and the other nozzles with the amplitudes within the normal ranges are referred to as “normal nozzles 21G”. Nozzles 21 that are the target of the first dummy ejection for discharging the mixed-color liquid are referred to as first nozzles FN1, and normal nozzles 21G other than the first nozzles FN1 are referred to as second nozzles FN2. Note that the first nozzles FN1, which are the nozzles 21 targeted for the first dummy ejection to prevent color mixture, are also color mixture prevention nozzles.

### First Embodiment

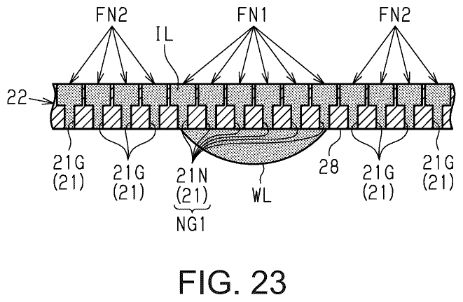

A first embodiment shown in FIGS. 22 and 23 will be described. In the first embodiment, only the first nozzle group NG1 in contact with the adhering liquid WL is subjected to the first dummy ejection. A first discharge amount, which is a dummy ejection amount from the nozzle 21 detected by the detection section 106, is set larger than a second ejection amount, which is a dummy ejection amount from other nozzles. The “dummy ejection amount from other nozzles” may include an ejection amount of 0. That is, the second dummy ejection amount may be zero.

### Second Embodiment

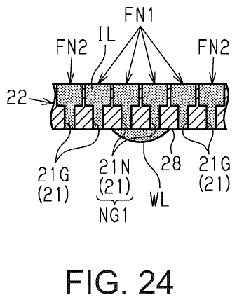

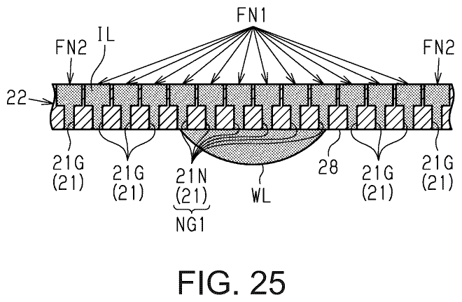

A second embodiment shown in FIGS. 24 and 25 will be described. In the second embodiment, not only the abnormal nozzles 21N that constitute the first nozzle groups NG1 and that are in contact with the adhering liquid WL, but also normal nozzles 21G that are “a” nozzles positioned continuous with the abnormal nozzle 21N, are set as the first nozzles FN1 which are the targets of the first dummy ejection.

In this case, as the number “A”, which is the number of abnormal nozzles 21N in contact with one adhering liquid WL, increases, the number of normal nozzles 21G that are continuous with and adjacent to the abnormal nozzle 21N and so should be the target of the first dummy ejection of the predetermined number “a”, increases. In a case shown in FIG. 24 where the number of abnormal nozzles 21N in contact with the adhering liquid WL is two, the predetermined number “a”, which is the number of the normal nozzle 21G that are continuous with and adjacent from the abnormal nozzle 21N and so should be the target of the first dummy ejection, is one, so a total of four nozzles are the first nozzles FN1. On the other hand, in the example of the cross-sectional view of the liquid ejection head 22 shown in FIG. 25, the number of abnormal nozzles 21N in contact with the large adhering liquid WL is six. In a case where the number of abnormal nozzles 21N in contact with the adhering liquid WL is six, the predetermined number “a”, which is the number of normal nozzles 21G that are continuous with and adjacent to the abnormal nozzle 21N and that are the target of the first dummy ejection, is three, and a total of twelve nozzles are the first nozzles FN1.

That is, as the number “A” of abnormal nozzles 21N, which are in contact with the adhering liquid WL, increases, the predetermined number “a”, which is the number of normal nozzles 21G, which are continuous with and adjacent to the abnormal nozzle 21N and which are target of the first ejection, also increases. In other words, when the number of abnormal nozzles 21N in contact with the adhering liquid WL is “B”, which is larger than A (B>A), then the predetermined number “a2” of normal nozzles 21G that are continuous with and adjacent to the abnormal nozzle 21N and that are targets of the first dummy ejection is set to a value larger than for the predetermined number a1 when the number is A (a2>a1).

### Third Embodiment

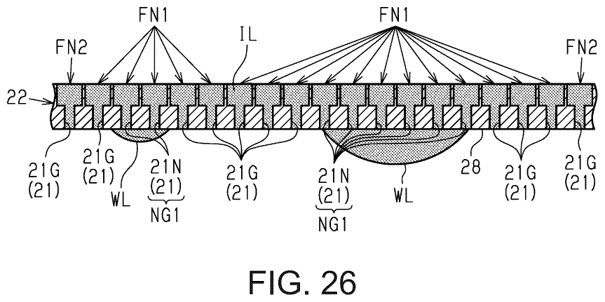

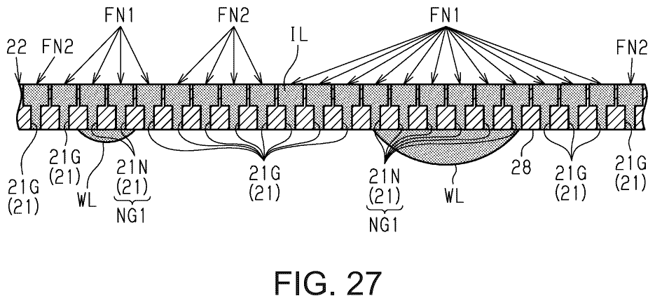

Next, a third embodiment shown in FIGS. 26 and 27 will be described. In the third embodiment, when more than one of liquid WL comes into contact with the nozzle surface 28, the normal nozzle 21G positioned between the plurality of adhering liquids WL is specified as a first nozzle FN1 by a method different from that of the second embodiment. In the third embodiment, when the number of normal nozzles 21G positioned between adhering liquids WL is equal to or less than a predetermined number “K”, then from the abnormal nozzles 21N to normal nozzles 21G, which are positioned “F1” nozzles away from and continuous with the abnormal nozzles 21N, are specified as the first nozzles FN1. The number “F1” is set to be larger than the predetermined number “a” in the second embodiment by “f1” (F1=a+f1). FIG. 26 shows an example in which “f1” is one. In this case, the nozzle nf can be specified as the first nozzle FN1 that is the target of the first dummy ejection, even if the erroneously detected nozzle nf shown in FIG. 21 exists. In this respect, the predetermined number “K” may be one or two, for example. The predetermined number “K” is not limited to one or two but may be set to an appropriate value within a range of K=3 to 10, for example, or may be set to a value exceeding 10.

FIG. 27 shows an example of a case where the number of normal nozzles 21G positioned between two adhering liquids WL exceeds the predetermined number “K”. In this case, as shown in FIG. 27, the normal nozzles 21G positioned among the plurality of contacted nozzle groups NG1 in contact with the plurality of adhering liquids WL are specified as the first nozzles FN1 by applying the method of the second embodiment. That is, a predetermined number “a” of normal nozzles 21G continuous with and adjacent to the abnormal nozzle 21N are specified as the first nozzles FN1 according to the number of abnormal nozzles 21N belonging to each of the plurality of contacted nozzle groups NG1 in contact with the plurality of adhering liquids WL.

### Operation of the Embodiment

Next, operations of the liquid ejection device 11 according to the embodiment will be described.

This will be described below with reference to the flowchart shown in FIG. 28. The control section 100 executes a cleaning control routine shown in FIG. 28 while the liquid ejection device 11 is powered on. By the execution of this routine, the first cleaning and wiping are performed when the wiping condition is satisfied.

First, in step S11, the control section 100 determines whether or not the wiping timing arrives. If the wiping timing arrives, it proceeds to step S12, if not the wiping timing, then it waits.

In step S12, the control section 100 pressurizes the nozzle. Specifically, the control section 100 controls the motor 70 to selectively control the selector valve 69, thereby closing the on-off valve 63 and pressurizing the head tank 64 in the closed state of the on-off valve 63. As a result, the membrane member 97 is deformed from the non-pressurizing position to the pressurizing position by the air introduced into the air chamber 96 of the head tank 64. As a result, the liquid in the liquid chamber 95 is pushed out to downstream in the liquid supply direction. The liquid IL in an amount corresponding to the volume of the liquid chamber 95 of the head tank 64 is pushed out from the nozzle 21. Due to the pressurization of the liquid, the liquid IL bulges from the nozzle 21 as shown in FIG. 11. That is, a bulging section EL is generated in which the liquid IL bulges from the nozzle 21 in the discharge direction beyond the nozzle surface 28. At this time, the bulging section EL may be formed as a result of a small amount of the liquid IL being ejected from the nozzle 21, or the liquid IL may be caused to bulge from the nozzle 21 without being ejected from the nozzle 21.

In step S13, the control section 100 performs wiping. Specifically, the control section 100 controls the motor 78 to move the wiping section 76 in the width direction X along the wiping path. Accordingly, the wiping section 76 wipes the nozzle surface 28 with the wiper blade 77. As a result, the nozzle surface 28 is wiped by the wiping section 76, and the bulging section EL bulges from the nozzle 21 is removed as shown in FIGS. 12 and 14. As shown in FIGS. 12 and 14, the liquid in the nozzle 21 is flattened so that the portion exposed to the nozzle opening is substantially flush with the nozzle surface 28.

After being wiped by the wiping section 76, a portion of the mixed-color liquid wiped by the wiping section 76 may remain on the nozzle surface 28 as shown in FIG. 14. For example, a part of the wiped liquid may remain on the nozzle surface 28 due to wear (for example, uneven wear), damage, uneven contact, vibration, or the like of the wiper blade 77 of the wiping section 76.

In step S14, the control section 100 performs the nozzle inspection. This nozzle inspection is performed in a state where the head tank 64 is at the pressurizing position. That is, before the membrane member 97 of the head tank 64 is returned from the pressurizing position to the non-pressurizing position after pressurization, the nozzle inspection is performed in a state where the membrane member 97 is at the pressurizing position. As shown in FIG. 14, since the presence of the mixed-color adhering liquid WL on the nozzle surface 28 cannot be detected after the mixed-color adhering liquid WL is sucked into the nozzle 21, the nozzle inspection is performed in a state in which the mixed-color adhering liquid WL is present on the nozzle surface 28. In the present embodiment, the adhering liquid WL adhering to the nozzle surface 28 is detected using the nozzle inspection.

The nozzle inspection is performed as follows. The diaphragm 265 is vibrated by applying a drive signal to the actuator 200. Next, the control section 100 switches the switching section 113. The abnormal-ejection detection section 112 inputs the residual vibration signals Vout. The nozzle 21 (abnormal nozzle 21N) in contact with the mixed color liquid WL is detected based on the residual vibration signals Vout. At this time, because the thickened liquid, the air bubbles, the paper powder, and the like in the nozzles 21 are already removed from the nozzles 21 by the first cleaning, it is possible to detect the nozzles 21 contacted by the mixed color liquid with less erroneous detection compared to a case where the detection is performed before the first cleaning. The processes of step S13 and step S14 correspond to “performing wiping of the nozzle surface 28 by the wiping section 76 and detection by the detection section 106 in a state where the operation at the time of pressurization of the pressurizing section 66 is maintained”.

In step S15, the control section 100 releases the pressurization of the nozzle 21. As a result, as shown in FIG. 13 and FIG. 15, the adhering liquid WL is sucked into the back of the nozzle 21. At this time, as shown in FIG. 15, the mixed-color adhering liquid WL in contact with the nozzle 21 is sucked into the back of the nozzle 21 by a predetermined amount corresponding to the volume of the liquid chamber 95.

The release of the pressurization may be performed at any timing after the nozzle inspection until the dummy ejection is performed. The process of step S15 corresponds to “releasing the pressurizing operation of the pressurizing section 66”.

In step S16, the control section 100 determines whether or not there is a contacted nozzle group. The control section 100 determines whether or not there is a contacted nozzle group based on the detection result of the detection section 106. If there is a contacted nozzle group, the process proceeds to step S17, and if there is no contacted nozzle group, the process proceeds to step S19. For example, as shown in FIG. 21, the control section 100 determines that nozzles 21 with amplitudes of residual vibration signals Vout within normal ranges are normal nozzles 21G and determines that nozzles 21 with amplitudes of residual vibration signals Vout that deviate from the normal ranges are abnormal nozzles 21N. The group of the abnormal nozzles 21N is the contacted nozzle group NG1 which contact adhering liquid WL. In the embodiment, the contacted nozzle group NG1 includes a case where the number of abnormal nozzles 21N is one.

In step S17, the control section 100 specifies color mixture prevention nozzles corresponding to the contacted nozzle group. Color mixture prevention nozzles are specified based on the abnormal nozzle 21N constituting the contacted nozzle group NG1, which were detected by the detection section 106 by any method of the first embodiment to the third embodiment. Color mixture prevention nozzle refers to the first nozzle FN1, which is a target nozzle of the first dummy ejection for ejecting the liquid in the first dummy ejection amount. By specifying the color mixture prevention nozzles, the color mixture prevention nozzles to which the first dummy ejection amount is set and the other normal nozzles 21G to which the second dummy ejection amount is set are set for all the nozzles 21. In other words, the first dummy ejection amount or the second dummy ejection amount is set for all the nozzles 21.

In the first embodiment shown in FIGS. 22 and 23, only the abnormal nozzles 21N constituting the contacted nozzle group NG1 are set as the first nozzles FN1, which are the target of the first dummy ejection. That is, the abnormal nozzles 21N are specified as the first nozzles FN1, which are a target of the first dummy ejection in which the liquid is ejected in the first dummy ejection amount, and the normal nozzles 21G are specified as the second nozzles FN2, which are a target of the second dummy ejection in which the liquid is ejected in the second dummy ejection amount. The process of step S17 for setting in the method of the first embodiment corresponds to “setting the first ejection amount, which is the dummy ejection amount from the nozzles detected by the detection section, to be larger than the second ejection amount, which is the dummy ejection amount from the other nozzles”.

In the second embodiment shown in FIGS. 24 and 25, the abnormal nozzle 21N and the predetermined number “a” of normal nozzles 21G continuous with and adjacent to the abnormal nozzle 21N are set as the first nozzles FN1 which is the target of the first dummy ejection. In this way, by specifying the color mixture prevention nozzles, the color mixture prevention nozzles (the first nozzles FN1) for which the first dummy ejection amount is set and the other normal nozzles 21G (the second nozzles FN2) for which the second dummy ejection amount is set are set for all the nozzles 21. In other words, the first dummy ejection amount or the second dummy ejection amount is set for all the nozzles 21. Note that the process of step S17 for setting in the method of the second embodiment corresponds to “setting the first ejection amount, which is the dummy ejection amount from the nozzle detected by the detection section 106 and the predetermined number “a” of nozzles continuous and adjacent to the nozzle, to be larger than the second ejection amount, which is the dummy ejection amount from the other nozzles”. Further, the process of step S17 set by the method of the second embodiment corresponds to “the predetermined number “a” is set to be larger as the number “A” of continuous and adjacent nozzles detected by the detection section 106 increases”. Here, the “number “A” of continuous and adjacent nozzles” may include an erroneously detected nozzle nf in which only one nozzle 21 is not detected in the contacted nozzle group NG1 detected by the detection section 106.

In the third embodiment shown in FIGS. 26 and 27, when the number of normal nozzles 21G that are positioned between a plurality of contacted nozzle groups NG1 in contact with more than one adhering liquid WL is equal to or less than the predetermined number K, the normal nozzle 21G positioned “F1” nozzles continuous with and adjacent to the abnormal nozzle 21N is specified as the first nozzle FN1. The number “F1” is set to be larger than the predetermined number “a” in the second embodiment by “f1” (F1=a+f1). The process of step S17 set in the method of the third embodiment corresponds to “when the number of nozzles between the plurality of contacted nozzle groups is equal to or smaller than the predetermined number, then set the dummy ejection amount from the nozzles that are between a plurality of contacted nozzle groups to be larger than the dummy ejection amount from the nozzles other than the contacted nozzle groups if a plurality of contacted nozzle groups are detected by the detection section”.

In step S18, the control section 100 performs the first dummy ejection from the color mixture prevention nozzle (the first nozzle FN1) and the second dummy ejection from the other normal nozzle 21G (the second nozzle FN2). The first ejection amount, which is the ejection amount of the first dummy ejection, is a discharge amount at which the mixed-color liquid WL can be discharged from the nozzles 21, and is greater than the second ejection amount, which is the discharge amount of the second dummy ejection, which is the normal dummy ejection. Note that the processing in step S18 corresponds to “performing dummy ejection, which is discharge of liquid unrelated to recording, from the plurality of nozzles based on the set dummy ejection amount”.

If it is determined in step S16 that there is no contacted nozzle group, the control section 100 executes the second dummy ejection from all the nozzles in step S19. That is, the dummy ejection is performed for all the nozzles 21 with the second dummy ejection amount smaller than the first dummy ejection amount.

### Effects of Embodiments

(1) The liquid ejection device 11 includes the liquid ejection section 20, the pressurizing section 66, the wiping section 76, and the detection section 106. The liquid ejection section 20 is configured to perform recording by ejecting liquid from a plurality of nozzle groups N1 to N4 formed on the nozzle surface 28. The pressurizing section 66 is configured to cause the liquid to bulge from the plurality of nozzle groups N1 to N4 by pressurizing the liquid in the plurality of nozzle groups N1 to N4. The wiping section 76 is configured to wipe the nozzle surface 28. The detection section 106 is configured to detect the nozzles 21 that contact liquid droplets adhering to the nozzle surface 28. The method of controlling the liquid ejection device 11 includes the following (a) to (e).

(a) The liquid is caused to bulge from the plurality of nozzle groups N1 to N4 by the pressurization of the pressurizing section 66.

(b) Wiping of the nozzle surface 28 by the wiping section 76 and detection by the detection section 106 are performed in a state where the operation at the time of pressurization of the pressurizing section 66 is maintained.

(c) The dummy ejection amount of each of the plurality of nozzles 21 constituting the plurality of nozzle groups N1 to N4 is set based on the detection result by the detection section 106.

(d) Releasing the pressurization of the pressurizing section 66.

(e) Based on the set dummy ejection amount, dummy ejection, which is ejection of liquid unrelated to recording, is performed from the plurality of nozzles 21.

According to this method, since it is possible to set the dummy ejection amount for preventing color mixing according to the state of each nozzle 21, it is possible to suppress a wasteful discharge of liquid from the nozzles 21.

(2) The method of controlling the liquid ejection device 11 includes setting the first ejection amount, which is the dummy ejection amount from the nozzles 21 detected by the detection section 106, to be larger than the second ejection amount, which is the dummy ejection amount from the other nozzles 21. According to this method, because the dummy ejection amount of the nozzle 21 in which color mixture is estimated to occur is increased, it is possible to suppress color mixture with a small dummy ejection amount as a whole.

(3) The method of controlling the liquid ejection device 11 includes setting a first ejection amount which is a dummy ejection amount from the nozzle 21 detected by the detection section 106 and a predetermined number of nozzles 21 continuous with and adjacent to the nozzle 21 to be larger than a second ejection amount which is an dummy ejection amount from the other nozzles 21. According to this method, because the dummy ejection amount is increased for the nozzle 21 in which color mixture may occur, it is possible to further suppress color mixing with a small dummy ejection amount as a whole.

(4) In the method of controlling the liquid ejection device 11, the predetermined number is set to be larger as the number of continuous and adjacent nozzles 21 detected by the detection section 106 increases. According to this method, the larger the number of continuous and adjacent nozzles 21 detected by the detection section 106 is, the higher the possibility of color mixture in more nozzles 21 in the vicinity thereof is. By considering this point, the color mixture can be further suppressed.

(5) The nozzle 21 which comes into contact with one droplet adhering to the nozzle surface 28 is referred to as a contacted nozzle group NG1. The method of controlling the liquid ejection device 11 includes setting the amount of dummy ejection from the nozzles 21 between the plurality of contacted nozzle groups NG1 to be larger than the amount of dummy ejection from the nozzles 21 other than the contacted nozzle groups NG1 if the number of nozzles 21 between the plurality of contacted nozzle groups NG1 is equal to or smaller than a specified number when the plurality of contacted nozzle groups NG1 is detected by the detection section 106. According to this method, because the dummy ejection amount is increased for the nozzle 21 in which color mixture may occur, it is possible to further suppress color mixing with a small dummy ejection amount as a whole.

(6) The liquid ejection device 11 includes the liquid ejection section 20, the pressurizing section 66, the wiping section 76, the detection section 106, and the control section 100. The liquid ejection section 20 is configured to perform recording by ejecting liquid from a plurality of nozzle groups N1 to N4 formed on the nozzle surface 28. The pressurizing section 66 is configured to cause the liquid to bulge from the plurality of nozzle groups N1 to N4 by pressurizing the liquid in the plurality of nozzle groups N1 to N4. The wiping section 76 is configured to wipe the nozzle surface 28. The detection section 106 is configured to detect the nozzles 21 that are in contact with the liquid droplets adhering to the nozzle surface 28. The control section 100 causes the liquid to bulge from the plurality of nozzle groups N1 to N4 by the pressurization of the pressurizing section 66. The control section 100 performs wiping of the nozzle surface 28 by the wiping section 76 and detection by the detection section 106 in a state in which the operation at the time of pressurization of the pressurizing section 66 is maintained. Further, the control section 100 sets the dummy ejection amount of each of the nozzles 21 constituting the nozzle groups N1 to N4 based on the detection result of the detection section 106. Then, the control section 100 releases the pressurization of the pressurizing section 66. Further, the control section 100 performs dummy ejection, which is ejection of liquid unrelated to recording, from the plurality of nozzles 21 based on the set dummy ejection amount. According to this configuration, since it is possible to set the dummy ejection amount for preventing color mixture according to the state of each of the nozzles 21, it is possible to suppress the wasteful discharge of liquid from the nozzles 21.

(7) The liquid ejection section 20 includes a plurality of actuators 200 provided corresponding to the plurality of nozzles 21 constituting the plurality of nozzle groups N1 to N4, and a plurality of diaphragms 265. The plurality of actuators 200 is individually driven by the head drive circuit 110, which is an example of a drive circuit, thereby partially displacing the plurality of diaphragms 265. The displaced diaphragm 265 causes the liquid to be ejected from the nozzle 21 corresponding to the driven actuator 200. The detection section 106 detects the nozzles 21 in contact with the liquid droplets adhering to the nozzle surface 28 based on the residual vibration of the displaced diaphragm 265. According to this configuration, because the nozzles 21 contacting liquid droplets adhering to the nozzle surface 28 are detected using the detection section 106 which detects the ejection failure of the nozzles 21 using the constituent elements of the liquid ejection section 20, it is not necessary to provide another detection section 106.

(8) The pressurizing section 66 includes the liquid chamber 95, the on-off valve 63, and the drive section 67. The liquid chamber 95 is provided at an intermediate position of the supply flow path 25 which supplies liquid to the liquid ejection section 20 and is configured such that the volume can be changed by the displacement of the membrane member 97. The on-off valve 63 is provided upstream of the liquid chamber 95 in the supply flow path 25 and is configured to open and close the supply flow path 25. The drive section 67 is configured to displace the membrane member 97. The control section 100 causes the liquid to bulge from the plurality of nozzle groups N1 to N4 by displacing the membrane member 97 in a direction in which the volume of the liquid chamber 95 is reduced by the drive section 67 in a state where the supply flow path 25 is closed by the on-off valve 63. According to this configuration, it is possible to cause the liquid to bulge from the nozzle 21 with a simple configuration.

### Modifications

The present embodiment can be implemented with the following modifications. The present embodiment and the following modifications can be implemented in combination with each other as long as there is no technical contradiction.
Each of the plurality of nozzles 21 constituting a single nozzle group is coupled to the reservoir 272 through the cavity 264 and the liquid supply inlet 271. Therefore, as in the third embodiment, when a plurality of adhering liquids WL is in contact with the nozzle surface 28, the smaller adhering liquid WL may be pulled into the nozzle 21 by the force of the larger adhering liquid WL trying to droop downward due to gravity. In a case where such a phenomenon occurs, there is a possibility that the detection section 106 cannot detect the presence of the smaller adhering liquid WL.

For this reason, in a case where even one nozzle 21 to which the adhering liquid WL is attached is detected by the detection section 106, the first dummy ejection with the first ejection amount may be performed with respect to all plurality of nozzles 21 which is coupled to the nozzle 21 to which the adhering liquid WL is detected to be attached through the reservoir 272.

In a case where there is another nozzle group adjacent to a nozzle group which includes a nozzle 21 in which the adhering liquid WL is detected, because there is a possibility that the same phenomenon occurs in that nozzle group, the first dummy ejection may be performed by the first ejection amount with respect to all of the plurality of nozzles 21 which configure the other adjacent nozzle group.
In a case where the detection section 106 is configured to detect the nozzle 21 in contact with the adhering liquid WL based on the residual vibration of the displaced diaphragm 265, it is also possible to detect the presence of air bubbles in the liquid in the nozzle 21 or the cavity 264.

When it is detected by the detection section 106 whether or not there is a nozzle 21 in contact with adhering liquid WL, in a case where it is detected that there is an air bubble in the nozzle 21 or the cavity 264, the residual vibration is affected by the air bubble, and there is a possibility that a nozzle 21 in contact with the adhering liquid WL cannot be correctly detected.

Therefore, when it is detected by the detection section 106 whether or not there is the nozzle 21 in contact with adhering liquid WL, in a case where the nozzle 21 or the cavity 264 in which air bubbles are present is detected, the first dummy ejection may be performed with the first ejection amount for all of the plurality of nozzles 21 in communication, via the reservoir 272, with the nozzle 21 or the cavity 264 in which air bubbles were detected.

In a case where there is another nozzle group adjacent to a nozzle group including a nozzle 21 or a cavity 264 in which an air bubble is detected, since there is a possibility that the same phenomenon occurs in the nozzle group, the first dummy ejection using the first ejection amount may be performed with respect to all of the plurality of nozzles 21 which configure another adjacent nozzle group. For the sake of safety, the first dummy ejection with the first ejection amount may be performed in all the nozzles 21 in the head (the unit-ejection heads 27 or the liquid ejection head 22) in which the presence of the air bubble is detected.
The setting of the dummy ejection amount based on the detection result of the detection section 106 (step S17) and the release of the pressurization of the pressurizing section 66 may be performed in any order or may be performed at the same time. The other operations are performed in the order of the steps shown in FIG. 28.
The detection of the nozzles with which the liquid IL adhering to the nozzle surface 28 comes into contact is not limited to a configuration in which the residual vibration of the diaphragm 265 is detected, and other detection methods may be used. For example, in the above-described embodiment, the detection section 106 used for nozzle inspection is used, but an imaging capture method may be used. The nozzles 21 in contact with the liquid attached to the nozzle surface 28 are detected by image analysis processing for analyzing an image obtained by photographing the nozzle surface 28 with a camera by an imaging capture method.
In the second embodiment, the predetermined number “a” is set to be larger as the number “A” of continuous and adjacent nozzles detected by the detection section 106 increases, but the predetermined number “a” may be set to be a constant value regardless of the number “A” of continuous and adjacent nozzles detected by the detection section 106.
The drive section 67 may be a motor that drives a pressurizing member (for example, a piston) that pressurizes the liquid in the liquid chamber 95, or may be a pump that sends the liquid in the supply flow path 25 to the downstream side and causes the liquid to bulge from the nozzle 21, instead of a configuration that includes the selector valve 69 or the like that causes the liquid to bulge from the nozzle 21 by pressurizing the liquid in the liquid chamber 95 by displacing the membrane member 97 using air pressure. The drive section 67 may include an air cylinder, a cam, or a solenoid.
In the above embodiment, the on-off valve 63 may be omitted. For example, a check valve or a throttle may be provided in place of the on-off valve 63. When the head tank 64 is moved from the non-pressurizing position to the pressurizing position, the liquid in the liquid chamber 95 may be blocked from flowing to the upstream side, or resistance for suppressing the amount of the liquid flowing to the upstream side may be applied.
The wiping section 76 is not limited to a blade type having the wiper blade 77 and may be a cloth wiper.
The liquid ejection device 11 is not limited to an inkjet printer that ejects liquid such as ink onto a medium M such as paper and may be a textile printing device that ejects liquid such as ink onto fabric.
The liquid ejection device 11 is not limited to a line printer and may be a serial printer or a page printer. For example, in a case of a serial printer, the liquid ejection section 20 is configured by a carriage, which can reciprocate along the width direction X, and the liquid ejection head 22 provided in the carriage. Then, printing is performed on the medium M by alternately performing a transport operation of transporting the medium M to the next printing position and a printing operation of ejecting liquid droplets from the nozzles 21 of the liquid ejection head 22 during the movement of the carriage.
The liquid ejection device 11 may be a printer that does not include the image reading section 13 and has only a printing function.
The liquid may be other than ink. For example, a coating liquid or a cleaning liquid may be used.
The liquid ejection device 11 is not limited to a printing device that ejects ink as an example of liquid. The liquid ejection device 11 may eject a liquid other than ink. The state of the liquid ejected as liquid droplets from the liquid ejection device 11 includes a granular shape, a tear drop shape, and a shape with a thread-like tail. Here, the liquid may be a material that can be ejected from the liquid ejection device 11. For example, the liquid may be in a state where a substance is in a liquid phase and includes a fluid body such as a liquid body having high or low viscosity, sol, gel water, other inorganic solvents, an organic solvent, a solution, a liquid resin, and a liquid metal (metal melt). The liquid includes not only a liquid as one state of a substance but also a liquid in which particles of a functional material made of a solid material such as a pigment or metal particles are dissolved, dispersed, or mixed in a solvent. Typical examples of the liquid include ink and liquid crystal as described in the above embodiment. Here, the ink includes various liquid compositions such as general water-based ink, oil-based ink, gel ink, and hot-melt ink. As a specific example of the liquid ejection device 11, for example, there is an apparatus that ejects a liquid containing a material such as an electrode material or a color material used for manufacturing a liquid crystal display, an electroluminescence (EL) display, a surface emitting display, a color filter, or the like in a dispersed or dissolved form. The liquid ejection device 11 may be a device that ejects a bioorganic material used for manufacturing a biochip, a device that is used as a precision pipette and ejects a liquid serving as a sample, a textile printing device, a micro dispenser, or the like. The liquid ejection device 11 may be a device that ejects a lubricant in a pinpoint manner to a precision machine such as a watch or a camera, or a device that ejects a transparent resin liquid such as an ultraviolet curable resin onto a substrate in order to form a micro hemispherical lens (optical lens) or the like used for an optical communication element or the like. The liquid ejection device 11 may be a device that ejects an etchant such as an acid or an alkali for etching a substrate or the like. Further, the liquid ejection device 11 may be a three-dimensional printer.

Hereinafter, technical ideas derived from the above-described embodiment and modifications and effects thereof will be described.

(A) A control method of a liquid ejection device, the liquid ejection device having a liquid ejection section configured to record by ejecting liquid from a plurality of nozzle groups formed in a nozzle surface, a pressurizing section configured to cause the liquid to bulge from the plurality of nozzle groups by pressurizing the liquid in the plurality of nozzle groups, a wiping section configured to wipe the nozzle surface, and a detection section configured to detect a nozzle that is in contact with a liquid droplet adhering to the nozzle surface, the control method of the liquid ejection device includes causing the liquid to bulge from the plurality of nozzle groups by pressurization of the pressurizing section, in a state where an operation at the time when pressurization by the pressurizing section is being maintained, performing wiping of the nozzle surface by the wiping section and detection by the detection section, based on a detection result by the detection section, setting a dummy ejection amount for each of the plurality of nozzles constituting the plurality of nozzle groups, releasing the pressurization of the pressurizing section, and based on the set dummy ejection amount, performing a dummy ejection, which is an ejection of liquid not related to the recording, from the plurality of nozzles. According to this method, since it is possible to set the dummy ejection amount for preventing color mixture in accordance with the state of each nozzle, it is possible to suppress the wasteful discharge of liquid from the nozzles.

(B) The control method of the liquid ejection device according to (A) may further include setting a first ejection amount, which is a dummy ejection amount from the nozzle detected by the detection section, to be larger than a second ejection amount, which is a dummy ejection amount from the other nozzles. According to this method, because the dummy ejection amount of the nozzle in which color mixture is estimated to occur is increased, it is possible to suppress color mixture with a small dummy ejection amount as a whole.

(C) The control method of the liquid ejection device according to (A) or (B) may further include setting a first ejection amount, which is a dummy ejection amount from the nozzle detected by the detection section and a predetermined number of nozzles continuous with and adjacent to the nozzle, to be larger than a second ejection amount, which is a dummy ejection amount from the other nozzles. According to this method, because the dummy ejection amount is increased for a nozzle in which color mixture may occur, it is possible to further suppress color mixing with a small dummy ejection amount as a whole.

(D) The control method of the liquid ejection device according to any one of (A) to (C) may further include setting the predetermined number to be larger as the number of continuous and adjacent nozzles detected by the detection section increases. According to this method, the larger the number of continuous and adjacent nozzles detected by the detection section, the higher the risk of color mixture in a larger number of nozzles in the vicinity thereof. By considering this point, the color mixture can be further suppressed.

(E) The control method of the liquid ejection device according to any one of (A) to (D) may further include defining nozzles in contact with one droplet adhering to the nozzle surface as a contacted nozzle group and, when a plurality of contacted nozzle groups are detected by the detection section, setting the amount of dummy ejections from the nozzles between the plurality of contacted nozzle groups to be larger than the amount of dummy ejection from nozzles other than the contacted nozzle groups if the number of nozzles between the plurality of contacted nozzle groups is equal to or less than a predetermined number. According to this method, because the dummy ejection amount is increased for a nozzle in which color mixture may occur, it is possible to further suppress color mixing with a small dummy ejection amount as a whole.

(F) A liquid ejection device includes a liquid ejection section configured to record by ejecting liquid from a plurality of nozzle groups formed on an nozzle surface, a pressurizing section configured to cause the liquid to bulge from the plurality of nozzle groups by pressurizing the liquid in the plurality of nozzle groups, a wiping section configured to wipe the nozzle surface, a detection section configured to detect a nozzle in contact with a droplet adhering to the nozzle surface, and control section, wherein the control section is configured to cause the liquid to bulge from the plurality of nozzle groups by the pressurization of the pressurizing section, in a state where an operation of the pressurizing section at the time of pressurization is maintained, execute wiping of the nozzle surface by the wiping section and detection by the detection section, set a dummy ejection amount of each of the plurality of nozzles constituting the plurality of nozzle groups based on a detection result by the detection section, releases the pressurization of the pressurizing section, and based on the set dummy ejection amount, execute dummy ejection which is ejection of liquid not related to the recording from the plurality of nozzles. According to this configuration, because it is possible to set the dummy ejection amount for preventing color mixture in accordance with the state of each nozzle, it is possible to suppress the wasteful discharge of liquid from the nozzles.

(G) In the liquid ejection device according to (F), the liquid ejection section may include a plurality of diaphragms and a plurality of actuators provided corresponding to the plurality of nozzles constituting the plurality of nozzle groups, the actuators may be individually driven by a drive circuit to partially displace the diaphragms, the displaced diaphragms may cause the nozzles corresponding to the driven actuators to eject the liquid, and the detection section may detect nozzles that are in contact with liquid droplets adhering to the nozzle surface based on residual vibration of the displaced diaphragms. According to this configuration, because the nozzle with which the liquid droplet adhering to the nozzle surface comes into contact is detected using the detection section which detects the ejection failure of the nozzle using the constituent element of the liquid ejection section, it is not necessary to provide another detection section.

(H) In the liquid ejection device according to (F) or (G), the pressurizing section includes a liquid chamber that is provided at an intermediate position of a supply flow path for supplying the liquid to the liquid ejection section and that has a volume that is changeable by displacement of a membrane member, an on-off valve provided upstream of the liquid chamber in the supply flow path and configured to open and to close the supply flow path, and a drive section configured to displace the membrane member, and in a state where the supply flow path is closed by the on-off valve, the control section causes the liquid to bulge from the plurality of nozzle groups by displacing the membrane member in a direction in which volume of the liquid chamber is reduced by the drive section. According to this configuration, it is possible to cause the liquid to bulge from the nozzle with a simple configuration.

What is claimed is:

1. A control method of a liquid ejection device,
the liquid ejection device including
a liquid ejection section configured to record by ejecting liquid from a plurality of nozzle groups formed in a nozzle surface,
a pressurizing section configured to cause the liquid to bulge from the plurality of nozzle groups by pressurizing the liquid in the plurality of nozzle groups,
a wiping section configured to wipe the nozzle surface, and
a detection section configured to detect a nozzle that is in contact with a liquid droplet adhering to the nozzle surface,
the control method of the liquid ejection device comprising:
causing the liquid to bulge from the plurality of nozzle groups by pressurization of the pressurizing section;
in a state where an operation at the time when pressurization by the pressurizing section is being maintained, performing wiping of the nozzle surface by the wiping section and detection by the detection section;
based on a detection result by the detection section, setting a dummy ejection amount for each of the plurality of nozzles constituting the plurality of nozzle groups;
releasing the pressurization of the pressurizing section; and
based on the set dummy ejection amount, performing a dummy ejection, which is an ejection of liquid not related to the recording, from the plurality of nozzles.

2. The control method of the liquid ejection device according to claim 1, further comprising:
setting a first ejection amount, which is a dummy ejection amount from the nozzle detected by the detection section, to be larger than a second ejection amount, which is a dummy ejection amount from the other nozzles.

3. The control method of the liquid ejection device according to claim 1, further comprising:
setting a first ejection amount, which is a dummy ejection amount from the nozzle detected by the detection section and a predetermined number of nozzles continuous with and adjacent to the nozzle, to be larger than a second ejection amount, which is a dummy ejection amount from the other nozzles.

4. The control method of the liquid ejection device according to claim 3, further comprising:
setting the predetermined number to be larger as the number of continuous and adjacent nozzles detected by the detection section increases.

5. The control method of the liquid ejection device according to claim 3, further comprising:
defining nozzles in contact with one droplet adhering to the nozzle surface as a contacted nozzle group and, when a plurality of contacted nozzle groups are detected by the detection section, setting the amount of dummy ejections from the nozzles between the plurality of contacted nozzle groups to be larger than the amount of dummy ejection from nozzles other than the contacted nozzle groups if the number of nozzles between the plurality of contacted nozzle groups is equal to or less than a predetermined number.

6. A liquid ejection device comprising:
a liquid ejection section configured to record by ejecting liquid from a plurality of nozzle groups formed in a nozzle surface,
a pressurizing section configured to cause the liquid to bulge from the plurality of nozzle groups by pressurizing the liquid in the plurality of nozzle groups;
a wiping section configured to wipe the nozzle surface;
a detection section configured to detect a nozzle that is in contact with a liquid droplet adhering to the nozzle surface; and
a control section, wherein
the control section is configured to
cause the liquid to bulge from the plurality of nozzle groups by pressurization of the pressurizing section,
in a state where an operation at the time when pressurization by the pressurizing section is being maintained, perform wiping of the nozzle surface by the wiping section and detection by the detection section,
based on a detection result by the detection section, set a dummy ejection amount for each of the plurality of nozzles constituting the plurality of nozzle groups,
release the pressurization of the pressurizing section, and
based on the set dummy ejection amounts, execute dummy ejection, which is ejection of liquid not related to the recording, from the plurality of nozzles.

7. The liquid ejection device according to claim 6, wherein
the liquid ejection section includes a plurality of diaphragms and a plurality of actuators provided corresponding to the plurality of nozzles constituting the plurality of nozzle groups,
the actuators are individually driven by a drive circuit to partially displace the diaphragms,
the displaced diaphragms cause the nozzles corresponding to the driven actuators to eject the liquid, and
the detection section detects nozzles that are in contact with liquid droplets adhering to the nozzle surface based on residual vibration of the displaced diaphragms.

8. The liquid ejection device according to claim 6, wherein
the pressurizing section includes
a liquid chamber that is provided at an intermediate position of a supply flow path for supplying the liquid to the liquid ejection section and that has a volume that is changeable by displacement of a membrane member,
an on-off valve provided upstream of the liquid chamber in the supply flow path and configured to open and to close the supply flow path, and
a drive section configured to displace the membrane member, and
in a state where the supply flow path is closed by the on-off valve, the control section causes the liquid to bulge from the plurality of nozzle groups by displacing the membrane member in a direction in which volume of the liquid chamber is reduced by the drive section.
